(19) United States
(12) Patent Application Publication
(10) Pub. No.: US 2004/0130974 A1
(43) Pub. Date: Jul. 8, 2004

(54) Magnetooptic recording medium and reproducing method therefor

(76) Inventors: Hiroyuki Awano, Noda-shi (JP); Masaki Sekine, Moriya-shi (JP); Manabu Tani, Moriya-shi (JP); Susumu Imai, Toride-shi (JP); Kazuko Inoue, Ryugasaki-shi (JP); Yoshikazu Suzuki, Otokuni-gun (JP); Yasukio Kokufuda, Yuki-gun (JP); Osamu Ishizaki, Makabe-gun (JP); Katsusuke Shimazaki, Toride-shi (JP)

Correspondence Address: Oliff & Berridge, PO Box 19928, Alexandria, VA, 22320, US

(21) Appl. No.: 10/472,807

(22) PCT Filed: Mar. 26, 2002
(86) PCT No.: PCT/JP02/02923

(30) Foreign Application Priority Data
Mar. 26, 2001 (JP) 2001-88398
Feb. 28, 2002 (JP) 2002-54614

(51) Int. Cl. G11B 11/00

(52) U.S. Cl. 369/13.38

(57) ABSTRACT

A magneto-optical recording medium comprises a recording layer 5, an intermediate layer 4, and a reproducing layer 3. The reproducing layer 3 is formed of a rare earth transition metal alloy in which rare earth metal is dominant, and each of the intermediate layer 4 and the recording layer 5 is formed of a rare earth transition metal alloy in which transition metal is dominant. The intermediate layer 4 exhibits in-plane magnetization at a temperature of not less than 140° C. Therefore, the intermediate layer 4 cuts off the exchange coupling force between the recording layer 5 and the reproducing layer 3 during the reproduction. A magnetic domain 3A, which is transferred to the reproducing layer 3, is expanded to a size of a minimum magnetic domain diameter by the magnetostatic repulsive force exerted between the magnetic domain in the intermediate layer 4 and the magnetic domain in the reproducing layer. It is possible to obtain a reproduced signal having an amplified intensity without generating any ghost signal by the magnetic domain expansion reproduction.

### TECHNICAL FIELD

The present invention relates to a magneto-optical recording medium and a reproducing method thereon. In particular, the present invention relates to a magneto-optical recording medium on which information recorded at a high density can be reproduced reliably at a sufficient reproduced signal intensity, and a reproducing method thereon.

### BACKGROUND ART

As the information oriented society is advanced, the recording density is remarkably improved for the external storage apparatus for storing an enormous amount of information. This situation is also brought about similarly in the case of the magneto-optical disk as the exchangeable medium. Research and development are being vigorously performed in order to realize the high density by decreasing the light spot size based on the use of the blue laser and the high NA lens. However, in the present circumstances, it is difficult to supply the blue laser cheaply in a large amount. Therefore, it is demanded to realize a large capacity with another technique while using the red laser. Such a technique is applicable as well when the blue laser can be supplied in a large amount in future. Therefore, it is considered that the recording will be successfully performed in a larger capacity. Based on the background as described above, several techniques to realize the large capacity, in which the features of the heat and the magnetism are utilized, have been suggested for the magneto-optical recording. The techniques to realize the large capacity as described above include, for example, the magnetic super resolution technique disclosed in Japanese Patent Application Laid-open No. 3-93056, the domain wall displacement detection technique disclosed in Japanese Patent Application Laid-open No. 6-290496, the magnetic domain expansion readout or reproduction technique, i.e., the magnetic amplifying MO system disclosed in Japanese Patent Application Laid-open No. 8-182901, and the center aperture rear expansion detection technique disclosed in Japanese Patent Application Laid-open No. 11-162030.

Assuming that λ represents the wavelength of the light beam to be used for the recording and reproduction and NA represents the numerical aperture of the objective lens, the diffraction limit of the collected light spot is represented by λ/NA, and the size, which is a half of the diffraction limit, represents the minimum reproducible or readable mark size. The light spot size of the blue laser is smaller than that of the red laser, because the wavelength λ of the blue laser is smaller than that of the red laser. Therefore, when the blue laser is used, it is possible to detect a reproduced signal from an area narrower than those used in the conventional technique. This means the fact that minute magnetic domains subjected to the high density recording can be used to effect the reproduction.

However, it is also possible to effectively narrow the signal reproduction area without decreasing the spot diameter of the laser beam. In the case of the magnetic super resolution (MSR) reproduction technique, the effective light spot diameter is decreased by utilizing the magnetization characteristics of the recording film with respect to the temperature. A reproducing layer and an intermediate layer having a low Curie temperature are provided on a recording film of a magneto-optical recording medium to be used for the magnetic super resolution reproduction technique. Any one of the three layers is formed by using a rare earth transition metal alloy in which the transition metal is dominant.

The magnetic characteristics of the magneto-optical recording medium based on the use of the magnetic super resolution reproduction technique are described in detail, for example, in Japanese Patent Application Laid-open No. 3-93056 and on page 54 of “Ultra High Density Magneto-Optical Recording Technology” (Triceps). An explanation will now be briefly made with reference to FIG. 49 about the principle of the magnetic super resolution described in Japanese Patent Application Laid-open No. 3-93056. FIG. 49 shows magnetization states of magnetic domains of a recording layer, an intermediate layer, and a reproducing layer of a magneto-optical recording medium for the magnetic super resolution at a low temperature respectively. The magnetic domains disposed in the recording layer are successively transferred to the intermediate layer and the reproducing layer, because the three layers are subjected to the exchange coupling. As conceptually shown in FIG. 49, the magnetic domains in the three layers are attracted to one another, and they are magnetostatically stable as well. When the magneto-optical recording medium is irradiated with a reproducing light beam having a large reproducing power and the intermediate layer is heated to a temperature not less than the Curie temperature, then the area (high temperature area) of the intermediate layer, in which the temperature exceeds the Curie temperature, loses the magnetization (becomes non-magnetic), and the exchange coupling is cut off between the magnetic domains of the recording layer and the reproducing layer which are disposed at the upper and lower positions of the area. On this condition, when a reproducing magnetic field (magnetic field for forming the mask) is applied, then the magnetization of the area of the reproducing layer in which the exchange coupling force is broken off is aligned in the direction of the reproducing magnetic field, and thus the magnetic mask is formed. Accordingly, the recording mark of the recording layer can be subjected to the reproduction through only the area in which the temperature is lower than the Curie temperature of the intermediate layer, i.e., through the narrow area which is not masked. A magnetic film having a small coercivity can be used for the reproducing layer of the magneto-optical recording medium. On this condition, when an external magnetic field is applied in a state in which the temperature of the light spot center is not less than the Curie temperature of the intermediate layer by radiating the reproducing light beam, the recording magnetic domains, which remain in the reproducing layer disposed closely to the non-magnetic portion of the intermediate layer having the temperature of not less than the Curie temperature, can be erased with ease by the external magnetic field. Therefore, the information of the recording magnetic domain is not transferred to the high temperature portion of the reproducing layer which functions as the magnetic mask. When the linear velocity is increased, the temperature distribution on the recording film, which is formed by being irradiated with the light beam, is displaced in a direction opposite to the traveling direction of the light spot. The recording magnetic domains can be subjected to the reproduction at positions disposed in front of the light spot. However, no information is reproduced at positions disposed at the back of the central portion of the light spot owing to the mask. The magnetic super resolution reproduction technique of this type is called “Front Aperture Detection” or “FAD”, because it uses the front portion of the light spot as the aperture. However, in the case of FAD, the more enhanced the resolution is (the more intensified the mask is), the smaller the areal size capable of receiving the reproduced signal is, resulting in the great decrease in absolute signal amount. This causes the problem when the magneto-optical recording medium is allowed to have a high density, which causes the limit to improve the recording density. Several types are known for the magnetic super resolution reproduction technique, including, for example, the center aperture detection and the rear aperture detection. However, the same or equivalent problem is involved in any one of the types of the magnetic super resolution reproduction technique.

In view of the above, the present inventors have disclosed, in Japanese Patent Application Laid-open No. 8-182901, the magnetic domain expansion reproduction (Magnetic Amplifying MO System), i.e., MAMMOS in which minute recording magnetic domains, which are recorded in a recording layer, are transferred to a reproducing layer, and they are expanded with a reproducing magnetic field to increase the reproduced signal. However, in the case of MAMMOS, a problem arises such that the construction of the apparatus is complicated, because the reproducing magnetic field is used to expand the magnetic domain.

On the other hand, the domain wall displacement detection technique is disclosed in Japanese Patent Application Laid-open No. 6-290496 as a technique for performing the reproduction with a high resolution while securing a necessary minimum signal intensity, although the absolute signal amount is not increased so much. A magneto-optical recording medium, which is used for the domain wall displacement detection technique, comprises a recording layer, an intermediate layer, and a reproducing layer in the same manner as in FAD described above. In the domain wall displacement detection technique, the magnetic domain, which is transferred from the recording layer to the reproducing layer, has its front domain wall for which the coupling with the recording layer is cut off in the area in which the intermediate layer is heated to be non-magnetic. The domain wall is moved or displaced to the thermal center (position of arrival at the highest temperature) existing in the light spot. As a result, the magnetic domain, which is transferred to the reproducing layer, is expanded, i.e., the areal size of the minute magnetic domain is effectively increased. Accordingly, the reproduced signal is slightly increased. This technique is called “Domain Wall Displacement Detection” or “DWDD” in view of the fact that the detection is performed by displacing the domain wall. This technique utilizes the force of the domain wall to move to the position at which the domain wall energy is low. Therefore, in order to successfully carry out this method, it is necessary that the saturation magnetization of each of the layers is decreased to be as small as possible so that the displacement of the domain wall is not obstructed, as described by the inventors on page 19, left column, lines 6 to 11 of a monthly publication, “Optical Alliance”, (July, 1998) published by Japan Industrial Publishing Co., Ltd. Therefore, any one of the recording layer, the intermediate layer, and the reproducing layer used for DWDD is composed of a magnetic material having a compensation temperature which is lower than the Curie temperature. This fact is also described on page 43, right column, line 3 from the bottom to page 44, left column, line 5 from the top of a paper MAG 98-189 of 1998 Technical Meeting of The Institute of Electrical Engineers of Japan.

According to DWDD, it is possible to perform the reproduction from minute magnetic domains. However, DWDD involves such a problem that the reproduced signal is small, which has merely a size of the lowest limit signal capable of being correctly reproduced. Further, DWDD is based on the principle described above. Therefore, it is appreciable that the magnetic domain is expanded at the position in front of the non-magnetized area of the intermediate layer. However, the magnetic domain is also similarly expanded at the back thereof. Therefore, the reproduced signal becomes complicated, which causes a serious problem of the practical use. The magnetic domain expansion from the back results in the excessive expanded signal appeared on the reproduced signal, which has been called “ghost signal”. The appearance of the ghost signal results from the fact that the action of the magnetic domain expansion is entrusted to only the domain wall energy.

In order to dissolve the ghost signal involved in DWDD, an intermediate layer is provided, in which the Curie temperature is slightly higher and the saturation magnetization is small. As a result, the improvement has been made a little. However, the circumstances are still insufficient in relation to the magnitude of the reproduced signal.

In the case of DWDD, it is indispensable to adopt the following methods. That is, it is indispensable that only the groove of the land-groove substrate is subjected to the high temperature annealing with a high laser power to lower the domain wall energy in order that the domain wall of the recording layer can be smoothly displaced. Further, it is indispensable that the groove depth of the land-groove substrate is made extremely deep so that the recording film is adhered substantially only slightly to the wall portion of the groove. However, the techniques as described above involve the following inconveniences. That is, it is difficult to manufacture a deep groove formed substrate at a high density track pitch in order to realize the high density. Further, in the case of the deep groove, it is extremely difficult to perform the correct recording with minute magnetic domains, as published by Kaneko et al. in INTERMAG 2000.

A technique for further increasing the displacement amount of the magnetic domain in DWDD is disclosed in Japanese Patent Application Laid-open No. 11-162030. According to this patent document, this technique uses an intermediate layer which is an in-plane magnetizable film, and a reproducing layer which is changed from an in-plane magnetizable film to a perpendicularly magnetizable film in the vicinity of the reproducing temperature. Therefore, the reproducing layer behaves as the in-plane magnetizable film at a temperature of not more than the predetermined temperature to form a mask. The domain wall can be displaced only at the central portion of the light spot at a temperature of not less than the predetermined temperature. When the arrangement as described above is adopted, then the coercivity of the reproducing layer is lowered, and the domain wall is displaced more smoothly. Therefore, this technique has such a feature that the amount of displacement of the domain wall is increased as compared with DWDD described above. This technique is called “CARED” (Center Aperture Rear Expansion Detection), because it resides in the domain wall displacement detection with the aperture disposed at only the central portion of the light spot.

However, the ghost signal also appears in CARED in the same manner as in DWDD. Therefore, it is likewise intended to avoid the ghost signal by adding a distinct magnetic layer as an additional intermediate layer. When the additional intermediate layer is added, the ghost can be avoided for the short magnetic mark. However, even in the case of CARED, the ghost signal cannot be avoided for the long magnetic mark, in the same manner as in DWDD. Therefore, only a signal processing system, which involves any length limitation, can be used for the recording and reproducing apparatus.

The present invention has been achieved in order to dissolve the inconveniences possessed by MSR, MAMMOS, DWDD, and CARED described above, a first object of which is to provide a magneto-optical recording medium which makes it possible to obtain a reproduced signal having a sufficient magnitude, a reproducing method thereon, and a reproducing apparatus therefor.

A second object of the present invention is to provide a magneto-optical recording medium on which no ghost signal appears irrelevant to the mark length of the recording mark, a magnetic domain-expanding reproducing method thereon, and an apparatus therefor.

A third object of the present invention is to provide a magneto-optical recording medium which makes it possible to execute the magnetic domain expansion reproduction on the magneto-optical recording medium without applying any reproducing magnetic field, a reproducing method thereon, and an apparatus therefor.

### DISCLOSURE OF THE INVENTION

According to the present invention, there is provided a magneto-optical recording medium comprising:

a recording layer which is formed of a magnetic material;

a reproducing layer which is formed of a magnetic material and which exhibits perpendicular magnetization; and

an intermediate layer which is formed of a magnetic material, which exists between the recording layer and the reproducing layer, and which cuts off an exchange coupling force between the recording layer and the reproducing layer at a temperature of not more than 160° C., wherein:

a compensation temperature Tcomp1 of the reproducing layer, a compensation temperature Tcomp2 of the intermediate layer, and a compensation temperature Tcomp3 of the recording layer satisfy one of the following expressions (1) and (2):

Tcomp2<120° C.<Tcomp1 (1)

Tcomp3<120° C.<Tcomp2 (2)

In the present invention, it is desirable that the reproducing layer exhibits the perpendicular magnetization within a temperature range of 20° C. to a temperature in the vicinity of a Curie temperature, and the compensation temperature is not less than the Curie temperature.

In the case of the magneto-optical recording medium of the present invention, the magnetic domain, which is transferred from the recording layer (hereinafter referred to as “information-recording layer” as well) via the intermediate layer to the reproducing layer (hereinafter referred to as “expanding reproducing layer” as well), can be detected by effecting the expansion by radiating the reproducing light beam without applying any external magnetic field. The magnetic domain can be expanded in the present invention on the basis of the factors including, for example, 1) the presence of the minimum magnetic domain diameter in the expanding reproducing layer, 2) the generation of the repulsive force between the intermediate layer and the recording layer or between the intermediate layer and the reproducing layer, and 3) the control of the exchange coupling force between the expanding reproducing layer and the recording layer. At first, an explanation will be made about the factors as described above. Subsequently, an explanation will be made about the principles of the expansion reproduction on the three types of the magneto-optical recording media for realizing the magneto-optical recording medium according to the present invention.

Factors of Expansion of Magnetic Domain

1) Principle of Magnetic Domain Expansion Owing to Presence of Minimum Magnetic Domain Diameter

In order to expand the magnetic domain of the reproducing layer without requiring any external magnetic field, it is necessary to consider the size of the minimum (stable) magnetic domain which is capable of existing stably in the reproducing layer. The minimum magnetic domain diameter d can be represented as d=σw/(Ms·Hc) provided that d represents the magnetic domain diameter of the minimum magnetic domain in the magnetic layer having a uniform temperature, σw represents the energy of the domain wall of the expanding reproducing layer, Ms represents the saturation magnetization, and Hc represents the coercivity. In general, d is large when Ms is relatively small, while d is small when Ms is large.

In the present invention, as shown in FIG. 1(a), a material, for example, GdFe is used as the material for the expanding reproducing layer 3, wherein the magnetic domain SM1, which is capable of existing magnetically stably in the expanding reproducing layer 3, has a relatively large minimum diameter (hereinafter referred to as “minimum magnetic domain diameter”). That is, any magnetic domain, which is smaller than the magnetic domain SM1, cannot exist stably in the expanding reproducing layer 3. On the other hand, as shown in FIG. 1(b), a magnetic material, for example, TbFeCo is used for the information-recording layer 5, wherein the minimum magnetic domain diameter of the magnetic domain SM2 is relatively small. Therefore, minute magnetic domains can be recorded at a high density in the information-recording layer 5. On this condition, when the expanding reproducing layer 3 and the information-recording layer 5 as described above are coupled to one another by the strong exchange coupling force, the magnetic domain SM2, which is recorded in the information-recording layer 5, is magnetically transferred to the expanding reproducing layer 3 to form the magnetic domain SM3 as shown in FIG. 1(c). However, the magnetic domain SM3, which has been magnetically transferred to the expanding reproducing layer 3, is unstable, because the magnetic domain SM3 is smaller than the minimum magnetic domain diameter in the expanding reproducing layer 3. Therefore, if the expanding reproducing layer 3 is separated from the information-recording layer 5 as shown in FIG. 1(d), the minute magnetic domain, which has been transferred to the expanding reproducing layer 3, is returned to the stable magnetic domain SM1 having the minimum magnetic domain diameter as shown in FIG. 1(a). In the present invention, the process of transition from FIG. 1(c) to FIG. 1(d) is executed by controlling the magnitude of the exchange coupling force between the expanding reproducing layer 3 and the information-recording layer 5 by using a variety of intermediate layers (expansion trigger layers) as described later on.

2) Exchange Coupling Force and Repulsive Force of Magnetic Layer

For example, a rare earth transition metal alloy may be used for the magnetic material for each of the recording layer, the intermediate layer, and the reproducing layer. A heavy rare earth is used for the rare earth. In this case, the magnetic spins of the rare earth metal and the transition metal are directed in mutually opposite directions. Therefore, the magnetic layer exhibits the ferrimagnetism. When the magnetic spins of the rare earth metal and the transition metal have an identical magnitude, the directions of magnetization are opposite to one another, i.e., the magnetizations are counteracted to one another. Therefore, the entire magnetization (sum of the magnetic spins) is zero. This state is called “compensation state”. The temperature, at which the compensation state is brought about, is called “compensation temperature”. The composition of the magnetic layer, with which the compensation state is brought about, is called “compensation composition”. The situation, in which the magnetic spin of the transition metal is larger than the magnetic spin of the rare earth metal, is called “transition metal rich” or “TM rich”. The situation, in which the magnetic spin of the rare earth metal is larger than the magnetic spin of the transition metal, is called “rare earth rich” or “RE rich”. In the present invention, the compensation temperature Tcomp1 of the reproducing layer, the compensation temperature Tcomp2 of the intermediate layer, and the compensation temperature Tcomp3 of the recording layer satisfy any one of the following expressions (1) and (2):

Tcomp2<120° C.<Tcomp1 (1)

Tcomp3<120° C.<Tcomp2 (2)

The expressions (1) and (2) represent the conditions of the presence of the repulsive force to serve as the trigger in order to cause the expansion of the magnetic domain in the present invention. In the case of the expression (1), the compensation temperature of the intermediate layer 4 exists at a temperature lower than 120° C., and the compensation temperature of the reproducing layer exists at a temperature higher than 120° C. For example, when each of the reproducing layer 3 and the intermediate layer 4 is composed of a ferrimagnetic rare earth transition metal, then the intermediate layer 4 is TM rich and the reproducing layer 3 is RE rich at 120° C. as shown in FIG. 2(a). Therefore, the magnetic spins (subnetwork magnetizations) of the transition metals of the intermediate layer 4 and the reproducing layer 3 are directed in the same direction, the magnetizations (entire magnetizations) are in mutually opposite directions, and the repulsive force is generated. In the present invention, the generation of the repulsive force as described above is the requirement for the magnetic domain expansion in the reproducing layer 3. When the recording layer 5 is constructed with a TM rich rare earth transition metal similarly to the intermediate layer 4, then the magnetic spins of the transition metals are continuous among the reproducing layer 3, the intermediate layer 4, and the recording layer 5, and the exchange coupling force is exerted between the reproducing layer 3 and the recording layer 5 via the intermediate layer 4. It is noted that the exchange coupling force is temperature-dependent. Therefore, when the temperature is raised from 120° C., then the repulsive force exceeds the exchange coupling force, and the magnetic domain in the reproducing layer 3 tends to be reversed. The reversal of the magnetic domain brings about the expansion of the magnetic domain.

In the case of the expression (2), the compensation temperature of the recording layer 5 exists at a temperature lower than 120° C., and the compensation temperature of the intermediate layer 4 exists at a temperature higher than 120° C. For example, when each of the recording layer 5 and the intermediate layer 4 is composed of a ferrimagnetic rare earth transition metal, then the recording layer 5 is TM rich and the intermediate layer is RE rich at 120° C. as shown in FIG. 2(b). Therefore, the magnetization of the recording layer 5 and the magnetization of the intermediate layer 4 are directed in mutually opposite directions, and the repulsive force is generated. On this condition, when the reproducing layer 3 is composed of an RE rich rare earth transition metal similarly to the intermediate layer 4, the exchange coupling force is exerted between the reproducing layer 3 and the recording layer 5 via the intermediate layer 4. The exchange coupling force is temperature-dependent. Therefore, when the temperature is raised from 120° C., then the repulsive force, which is generated by the magnetization of the recording layer 5 and the magnetizations of the reproducing layer 3 and the intermediate layer 4, exceeds the exchange coupling force between the recording layer 5 and the reproducing layer 3, and the magnetic domains in the intermediate layer 4 and the reproducing layer 3 tend to be reversed respectively. The reversal of the magnetic domain in the reproducing layer 3 brings about the expansion of the magnetic domain. When any one of the expressions (1) and (2) described above is satisfied, the repulsive force, which serves as an opportunity for the magnetic domain expansion in the present invention, is generated. An explanation will be made by mainly using the condition of the expression (1) to describe the principle of reproduction on each of the magneto-optical recording media of the respective types described below.

As described above, in the present invention, the relationship between the repulsive force and the exchange coupling force controls the magnetic domain expansion. The temperature of 120° C. assumes the temperature of an area in which the magnetic domain expansion will begin to occur by being irradiated with the reproducing light beam. That is, in the present invention, the area, in which the magnetic domain expansion begins to occur, is the circumferential edge, i.e., the low temperature portion, and it is not the central portion, i.e., the high temperature portion (thermal center) of the area which is heated by being irradiated with the reproducing light beam. On the other hand, the exchange coupling force between the recording layer and the expanding reproducing layer is cut off at the high temperature portion as described later on. In the present invention, it is assumed that the high temperature area has a temperature exceeding 140° C.

4) Control of Exchange Coupling Force

In the magneto-optical recording medium of the present invention, the intermediate layer controls the magnitudes of the repulsive force and the exchange coupling force exerted between the recording layer and the expanding reproducing layer in any one of the types of the magneto-optical recording media. Accordingly, the magnetic domain expansion to be caused in the expanding reproducing layer is optimized, and the occurrence of any ghost signal is avoided. In particular, during the reproduction of information, the intermediate layer cuts off the exchange coupling force exerted between the recording layer and the expanding reproducing layer in the high temperature area in the area which is irradiated with the reproducing light beam, and thus the magnetic domain of the expanding reproducing layer in the low temperature area is expanded to the high temperature area. The temperature, at which the exchange coupling force is cut off, is referred to as “exchange coupling force cutoff temperature”. The exchange coupling force cutoff temperature can be determined from the temperature dependency of the exchange coupling force (exchange coupling magnetic field). The exchange coupling force can be determined from the magnetic field dependency of the magneto-optical Kerr rotation angle from the side of the expanding reproducing layer. FIG. 25 shows an example of the measurement of the hysteresis curve of the magneto-optical Kerr rotation angle (θ) of the magneto-optical recording medium of the present invention at room temperature. The exchange coupling force (exchange coupling magnetic field), which is exerted from the information-recording layer having the large coercivity, acts as the bias magnetic field on the expanding reproducing layer. Therefore, the hysteresis curve is shifted to the left in an amount corresponding to the magnetic field. The shift amount is the exchange coupling force. FIG. 44 shows an example of the temperature dependency of the exchange coupling force. The exchange coupling force cutoff temperature corresponds the temperature at which the exchange coupling force is approximately zero.

Magneto-Optical Recording Medium of First Type

In order to control the magnitude of the exchange coupling force between the expanding reproducing layer and the information-recording layer, the magneto-optical recording medium of the first type uses an intermediate layer which exhibits the in-plane magnetization at a high temperature, for example, a temperature of not less than 140° C. and which exhibits the perpendicular magnetization at a low temperature, for example, a temperature of not more than 120° C. A magnetic layer, which exhibits the perpendicular magnetization, may be used for each of the recording layer and the reproducing layer. In this arrangement, when the intermediate layer exhibits the perpendicular magnetization, the exchange coupling force between the expanding reproducing layer and the information-recording layer via the intermediate layer is strong. However, when the intermediate layer exhibits the in-plane magnetization at a high temperature, then the exchange coupling force between the expanding reproducing layer and the information-recording layer is broken or cut off by the intermediate layer, and the exchange coupling force is weakened. In order to increase the exchange coupling force between the expanding reproducing layer and the information-recording layer at low temperatures, it is recommended that the Curie temperature Tc2 of the intermediate layer is made higher than the Curie temperature Tc1 of the expanding reproducing layer. However, in order to avoid any harmful influence on the recording into the information-recording layer, it is necessary that Tc2 is made lower than the Curie temperature Tc3 of the information-recording layer. Therefore, in the magneto-optical recording medium of the first type, the relationship among the Curie temperatures of the magnetic layers may satisfy Tc1<Tc2<Tc3.

As shown in FIG. 3, the following magneto-optical recording medium is now assumed. That is, the intermediate layer, for example, the expansion trigger layer 4′, which exhibits the in-plane magnetization at high temperatures and which exhibits the perpendicular magnetization at low temperatures, exists between the information-recording layer 5 and the expanding reproducing layer 3. It is assumed that minute magnetic domains are recorded at a high density in the recording layer 5. When the laser beam is not radiated, the magnetic domain 5A, which is recorded in the information-recording layer 5, is magnetically transferred to the expanding reproducing layer 3 to form the magnetic domain 3A by the aid of the large exchange coupling force exerted between the expanding reproducing layer 3 and the information-recording layer 5 via the expansion trigger layer 4′. As shown in FIG. 4, when the laser beam is radiated while allowing the magneto-optical recording medium to advance in the direction of the arrow DD, the temperature of the area of the magneto-optical recording medium, which is included in the laser spot, is raised. The magnetic anisotropy of the expansion trigger layer 4′ is suddenly decreased especially at the high temperature portion (for example, not less than 140° C.) of the area subjected to the increase in temperature in this situation. Therefore, the easy axis of magnetization of the expansion trigger layer 4′ is directed from the perpendicular direction to the film surface direction. In this situation, the perpendicular magnetization component of the expansion trigger layer 4′ is decreased, and hence the exchange coupling force between the expanding reproducing layer 3 and the information-recording layer 5 is suddenly lowered and cut off. It is assumed that the temperature, at which the exchange coupling force is cut off, is designated as Tr. As shown in FIG. 5, the expanding reproducing layer 3 and the information-recording layer 5 are in a state of being magnetically independent from each other in the temperature area exceeding Tr. Tr is, for example, 120° C. to 180° C. and preferably 140° C. to 180° C.

When the magneto-optical recording medium is further advanced in the direction of the arrow DD, and the recording magnetic domain 5A approaches the position in the vicinity of the area of the temperature T>Tr as shown in FIG. 6, then the magnetostatic repulsive force, which is brought about by the combined magnetization of the magnetization of the magnetic domain 5A of the information-recording layer 5 and the magnetization of the magnetic domain 4′A of the expansion trigger layer 4′ and the magnetization of the transferred magnetic domain 3A of the expanding reproducing layer 3, overcomes the exchange coupling force which is brought about by the magnetic domain 3A of the expanding reproducing layer 3 and the magnetic domain 5A of the information-recording layer 5 via the expansion trigger layer 4′. In particular, the magnetic domain 3B of the expanding reproducing layer 3 is the magnetic domain which is transferred by the exchange coupling force from the magnetic domain 5B of the recording layer 5. However, the repulsive force with respect to the magnetic domain 4′B of the expansion trigger layer is stronger than the exchange coupling force, because of the presence in the laser spot. Further, as described above, the stable magnetic domain diameter of the expanding reproducing layer 3 is large. Therefore, the force to make the restoration to the original size is exerted on the magnetic domain 3A. Accordingly, the magnetic pressure acts on the domain wall (3AF) between the magnetic domain 3A and the magnetic domain 3B, and the magnetic domain 3B is reversed as shown in FIG. 7. As a result, the magnetic domain 3A is expanded. The expanded magnetic domain 3A spreads over the entire region in the vicinity of the area in which the exchange coupling force is weakened as shown in FIG. 8. It may be also considered that the expanded area has a size corresponding to the stable magnetic domain diameter of the expanding reproducing layer 3. As described above, the expansion trigger layer 4′ provides the opportunity for the magnetic domain of the expanding reproducing layer 3 to expand in accordance with the temperature change.

In this situation, the following feature is important. That is, the rear edge 3AR is not moved or displaced even when the front edge 3AF (see FIG. 6) of the magnetic domain 3A is expanded toward the spot center during the expansion of the magnetic domain 3A, for the following reason. That is, if the rear edge 3AR is also displaced toward the spot center in cooperation with the expansion of the front edge 3AF, the areal size of the magnetic domain 3A is not increased. Therefore, the following feature is important for the magnetic domain-expanding reproducing layer 3. That is, the front edge 3AF tends to be expanded, and the rear edge 3AR, which has the temperature slightly lower than that of the front edge 3AF, is not displaced to retain the state as it is in which the magnetic domain of the recording layer 5 is transferred. In order to achieve this feature, it is recommended to use a material in which the temperature gradient of the exchange coupling force is steep in the vicinity of Tr. Experimentally, it is desirable that the temperature gradient is not less than −100 (Oe/° C.) in the vicinity of 130° C. which is considered to be in the vicinity of Tr. There is such a tendency that the expansion is hardly caused if the film thickness of the expanding reproducing layer 3 is thick. The film thickness of the expanding reproducing layer 3 is preferably 15 to 30 nm.

FIG. 9 shows a situation in which the magneto-optical recording medium is moved with respect to the light spot, and the magnetic domain 5C, which is adjacent to the magnetic domain 5A, is expanded and reproduced in accordance with the principle of the present invention. FIG. 10 shows a situation in which the magneto-optical recording medium is further moved with respect to the light spot, and the magnetic domain 5D, which is adjacent to the magnetic domain 5C having been reproduced in FIG. 9, is expanded and reproduced. As appreciated from FIG. 10, the magnetic domain 5A of the information-recording layer 5, which is located in the temperature area having a temperature exceeding Tr, emits the leak magnetic field toward the expanding reproducing layer 3. However, the leak magnetic field is cut off or shielded, because the magnetic domain of the expansion trigger layer 4′, which is located thereover, exhibits the in-plane magnetization. Therefore, even when the magnetic domain of the recording layer 5 positioned in the area in which the expansion takes place is directed in any direction, the expanding action of the expanding reproducing layer 3 is not affected thereby.

As shown in FIG. 11, the recording magnetic domain 5A, for which the reproduction has been completed after the expanding reproduction, is cooled when the recording magnetic domain 5A is released from the light spot. The perpendicular magnetic anisotropy of the magnetic domain 4′A of the expansion trigger layer 4′ is revived in the area in which the cooling is advanced. Therefore, the exchange coupling between the magnetic domain 3A of the expanding reproducing layer 3 and the magnetic domain 5A of the recording layer 5 is revived. However, the magnetic domain 5A is not transferred to the expanding reproducing layer 3, because the magnetostatic repulsive force overcomes the exchange coupling force. In the case of a situation shown in FIG. 12 in which the magnetic domain 3A is separated from the spot, the exchange coupling force is increased. However, a large amount of energy is required to transfer the minute magnetic domain to the expanding reproducing layer 3, in view of the stable magnetic domain diameter of the expanding reproducing layer 3 as having been explained with reference to FIG. 1. Therefore, the magnetic domain 5A of the recording layer is not transferred to the expanding reproducing layer 3 even in this state. Therefore, the ghost signal does not appear in the present invention, which would be otherwise caused such that the magnetic domain 5A of the recording layer, for which the reproduction of information has been completed, is retransferred to the expanding reproducing layer 3.

Magneto-Optical Recording Medium of Second Type

An explanation will be made below with reference to drawings about the principle of operation of the magneto-optical recording medium of the second type. Any one of the recording layer, the intermediate layer, and the reproducing layer of the magneto-optical recording medium of this type is formed by using the rare earth transition metal alloy which exhibits the perpendicular magnetization. The intermediate layer has the Curie temperature of not more than 160° C. and the compensation temperature of not more than room temperature. Therefore, when the magneto-optical recording medium is heated by being irradiated with the reproducing light beam, the magnetization disappears in the high temperature area (not less than 160° C.) of the intermediate layer. FIG. 13 shows states of respective magnetic domains of the recording layer 5, the intermediate layer 4, and the reproducing layer 3 of the magneto-optical recording medium before being irradiated with the reproducing light beam. It is assumed that all of the respective magnetic domains of the respective layers have an identical size in the disk-traveling direction. In FIG. 13, thick arrows (blanked arrows) indicate entire (combined) magnetizations of the respective layers. Thin arrows, which are depicted at the inside of the thick arrows, indicate the magnetic spins of the transition metals (Fe and Co). In the case of the magneto-optical recording medium of this type, when the magneto-optical recording medium is heated to a temperature in the vicinity of the reproducing temperature (for example, 120° C. to 200° C.) by being irradiated with the reproducing light beam during the reproduction, the following condition is satisfied as shown in FIG. 13. That is, the reproducing layer 3 is RE rich, and the intermediate layer 4 and the recording layer 5 are TM rich (the expression (1) is satisfied). Alternatively, the reproducing layer 3 and the intermediate layer 4 are RE rich, and the recording layer 5 is TM rich (the expression (2) is satisfied).

The respective transition metals of the recording layer 5, the intermediate layer 4, and the reproducing layer 3 are coupled to one another by the aid of the strong coupling force of not less than several 10 kOe at room temperature. Therefore, as shown in FIG. 13, all of the thin arrows, which indicate the magnetic spins, are directed in the same direction in the magnetic domains disposed in an identical vertical column of the transition metals of the recording layer 5, the intermediate layer 4, and the reproducing layer 3. The intermediate layer 4 and the recording layer 5 are TM rich. Therefore, the entire magnetization thereof is directed in the same direction as that of the spin of the transition metal in the magnetic domains included in the same vertical column. On the other hand, the reproducing layer 3 is RE rich. Therefore, the entire magnetization is directed in the direction opposite to that of the spin of the transition metal. That is, the entire magnetization of the magnetic domain in the reproducing layer 3 is directed mutually oppositely to the entire magnetizations of the intermediate layer 4 and the recording layer 5 disposed thereunder. The magnetic domain of the recording layer 5 is transferred in the opposite direction to the reproducing layer 3. It is now assumed that the respective magnetic domains of the reproducing layer 3 and the intermediate layer 4 are conceptually regarded as magnets 3a, 3b as shown on the right side in FIG. 13. The state, in which the entire magnetizations of the reproducing layer 3 and the intermediate layer 4 are directed in the mutually opposite directions, is similar or equivalent to the state in which the same poles of the magnets 3a, 3b are disposed closely to one another. This state is extremely unstable magnetostatically. That is, the state is unstable due to the repulsive force of the magnetostatic energy exerted between the intermediate layer 4 and the reproducing layer 3. However, the exchange coupling force, which is mutually brought about by the spins of the transition metals of the reproducing layer 3 and the intermediate layer 4, is stronger than the repulsive force of the magnetostatic energy. Therefore, the state is continued as shown in FIG. 13, in which the entire magnetizations of the reproducing layer 3 and the intermediate layer 4 are directed in the mutually opposite directions.

When the reproducing laser beam is collected with an objective lens and radiated onto the magneto-optical recording medium as shown in FIG. 14(a) so that the light spot S is formed on the reproducing layer 3 in order to reproduce information, then the temperature distribution is generated in the light spot S in accordance with the light intensity distribution of the laser beam, and especially the temperature is raised at portions in the vicinity of the center of the light spot S. In this situation, the magnetization disappears in the area 11 (hereinafter referred to as “reproducing temperature area”) of the intermediate layer 4 which is heated to a temperature of not less than the Curie temperature. The magnetic coupling (exchange coupling) is lost between the magnetic domain 15 of the recording layer 5 and the magnetic domain 13 of the reproducing layer 3 disposed over and under the reproducing temperature area 11 of the intermediate layer respectively. As described above, the intermediate layer 4 cuts off the exchange coupling force between the recording layer 5 and the reproducing layer 3 by being heated by the radiation of the laser beam. Therefore, the intermediate layer can be also called “exchange coupling force cutoff layer”.

A consideration will now be made as shown in FIG. 14(a) about the magnetic domain 23 of the reproducing layer 3 disposed adjacently to the portion in which the magnetization of the reproducing temperature area 11 of the intermediate layer 4 disappears by being heated by the radiation of the reproducing laser beam, and the magnetic domain of the intermediate layer 4 disposed thereunder. In this situation, the magnetic domain 13, which exists in the reproducing temperature area of the reproducing layer 3, also loses the exchange coupling force with respect to the recording magnetic domain 15 of the recording layer 5. On this condition, it is considered that the transferred magnetic domain 23, which is included in the light spot of the reproducing layer 3, is either expanded as shown in FIG. 14(b) or shrunk as shown in FIG. 14(c).

As shown in FIG. 15(a), it is assumed that the domain wall 26 of the magnetic domain 23 of the reproducing layer 3 is not displaced and the state is maintained as it is when the reproducing laser beam is radiated. On this assumption, the relationship between the repulsive force of the magnetostatic energy exerted on the lower surface of the reproducing layer 3 and the attracting force (exchange coupling force) of the exchange energy is shown in FIG. 15(b). As shown in FIG. 15(a), the large attracting force of the exchange energy and the relatively large repulsive force of the magnetostatic energy are exerted on the reproducing layer 3 in a state in which the temperature is still low at the portion disposed on the right side in the reproducing light spot. The attracting force of the exchange energy is the attracting force which is generated on the basis of the exchange coupling energy between the transition metal of the reproducing layer 3 and the transition metal of the intermediate layer 4. The attracting force exhibits an extremely large value in the low temperature area, because the transition metals mutually exhibit the strong coupling force. The attracting force exceeds the repulsive force of the magnetostatic energy. The attracting force of the exchange energy is suddenly decreased in accordance with the approach from the low temperature area to the reproducing temperature area. The attracting force of the exchange energy is zero in the reproducing temperature area, for the following reason. That is, the magnetization of the intermediate layer 4, is lost in the reproducing temperature area, and the exchange coupling force disappears. On the other hand, the repulsive force of the magnetostatic energy is the repulsive force which is based on the magnetostatic energy acting between the entire magnetization of the intermediate layer and the entire magnetization of the reproducing layer directed in the mutually opposite directions. The magnetostatic repulsive force exceeds the exchange coupling force in the area 4A of the intermediate layer 4. As shown in FIG. 15(b), the repulsive force of the magnetostatic energy is decreased, because the magnetization of the intermediate layer 4 is decreased in accordance with the approach from the low temperature area to the reproducing temperature area. However, the repulsive force of the magnetostatic energy is not zero even in the reproducing temperature area, and it has a predetermined value. That is, the repulsive force of the magnetostatic energy acts on the magnetic domain 27 of the reproducing layer in the reproducing temperature area, for the following reason. That is, as shown in FIG. 15(a), the magnetization of the magnetic domain 27 of the reproducing layer in the reproducing temperature area is directed.oppositely to the magnetization of the magnetic domain 28 of the recording layer in the reproducing temperature area, and the repulsive force is exerted between the magnetic domains. In this case, as shown in FIG. 16(a), the repulsive force of the magnetostatic energy firstly exceeds the attracting force of the exchange energy in the magnetic domain 23′ disposed on the left side of the magnetic domain 23 of the reproducing layer 3. Accordingly, the magnetic domain 23′ is reversed. The minimum magnetic domain diameter of the expanding reproducing layer is larger than the minimum magnetic domain diameter of the recording magnetic domain. The magnetic characteristics are adjusted (80 μemu/cm²<(saturation magnetization of reproducing layer)×(film thickness)<220 μemu/cm²) so that the minimum magnetic domain diameter is approximately equivalent to the diameter of the light spot. Therefore, the magnetic domain of the expanding reproducing layer is expanded to be approximately equal to the light spot diameter as indicated by the magnetic domain 23A shown in FIG. 16(b). In this situation, as shown in FIG. 16(b), the magnetization of the expanded magnetic domain 23A of the reproducing layer is directed in the same direction as that of the magnetization of the magnetic domain 28 of the recording layer. Therefore, the repulsive force of the magnetostatic energy is further decreased. That is, the transferred magnetic domain 23 in the reproducing temperature area in the light spot of the expanding reproducing layer 3 shown in FIG. 14(a) is expanded as shown in FIG. 14(b). This results from such a magnetic property that any small magnetic domain cannot be maintained due to the size of the minimum magnetic domain diameter when the magnetization of the expanding reproducing layer 3 is relatively small. When the magnetic domain expansion as described above is utilized, a large reproduced signal can be detected from the reproducing layer. FIG. 19 shows a situation in which the disk is further advanced in the direction of the arrow and the recording magnetic domain 25 shown in FIG. 16(b) is displaced to the high temperature portion in the light spot. In this situation, the leak magnetic field is exerted from the recording magnetic domain 25 to the expanding reproducing layer 3. However, the minimum magnetic domain diameter, at which the transfer can be effected, exists in the expanding reproducing layer 3 as described above. Therefore, it is impossible to transfer any magnetic domain smaller than the minimum magnetic domain diameter. That is, the state of the recording layer 5 at the high temperature portion (recording magnetic domain 25) is not transferred to the expanding reproducing layer 3.

As shown in FIG. 14(c), when the transferred magnetic domain is shrunk in the reproducing layer, the state is unstable in view of the energy, because the magnetostatic energy is increased in the reproducing layer. Therefore, it is considered that the shrinkage of the magnetic domain 23 as shown in FIG. 14(c) does not occur.

In order to expand the magnetic domain in the reproducing layer more satisfactorily, it is preferable that the intermediate layer has the large perpendicular magnetic anisotropy energy (Ku) and the intermediate layer is in a form of the perpendicularly magnetizable film until the temperature arrives at a temperature in the vicinity of the Curie temperature. FIGS. 17(a) and 17(b) show an example in which Ku of the intermediate layer is small. When Ku of the intermediate layer 4 is small, the magnetic domain 59 of the intermediate layer 4 at a temperature in the vicinity of the Curie temperature is directed in the in-plane direction due to the repulsive force of the magnetostatic energy exerted from the reproducing layer 3. Therefore, as shown in FIG. 17(b), the expansion of the magnetic domain of the reproducing layer 3 occurs in the reproducing layer area 23B disposed just over the non-magnetic area (Tc≦T) at a temperature of not less than the Curie temperature of the intermediate layer 4, and hence the ratio of expansion is small. Further, in this case, it is feared that the place, at which the coupling between the reproducing layer and the intermediate layer is broken, may be ambiguous, and the amount of jitter may be increased. Therefore, it is preferable that the intermediate layer 4 has the large perpendicular magnetic anisotropy. However, when an experiment was performed such that a TbFe alloy, which had the largest Ku and which had the Curie temperature in the vicinity of 150° C., was used for the intermediate layer, then the temperature gradient of the attracting force of the exchange energy was too steep. For this reason, the seeds of the magnetic domain expansion caused by the repulsive force of the magnetostatic energy as shown in FIG. 16(a) were nonuniform in some cases. According to the experimental result, it has been revealed that Ku of the intermediate layer is preferably 0.4 erg/cm³ to 1 erg/cm³. According to the experimental result, the most appropriate intermediate layer, which was especially usable in order to lower the error rate, was obtained when a TbGdFe alloy was used. In this case, the atomic ratio of Gd with respect to Tb was not more than ⅕. Relatively satisfactory results of the recording and reproduction are also obtained by adding, for example, a non-magnetic metal to the TbFeCo alloy to decrease Ku so that the value of Ku is within the range described above.

An explanation will now be made below with reference to drawings about the reason why the ghost signal, which has been generated in DWDD and CARED, is avoided when the magnetic domain expansion reproduction is performed on the magneto-optical recording medium of the second type.

FIG. 18(a) shows a situation brought about when the medium is scanned across the light spot, in which the recording magnetic domain 25 of the recording layer 5 existing in the light spot is transferred to the intermediate layer 4 which recovers the magnetization again by being cooled to a temperature of not more than the Curie temperature, and thus the retransferred magnetic domain 31 is generated. In this situation, the repulsive force of the magnetostatic energy is strong on the high temperature side of the retransferred magnetic domain 31 of the intermediate layer, i.e., in the area 31A disposed on the right side. Therefore, the exchange coupling cannot be formed by the retransferred magnetic domain 31 of the intermediate layer and the magnetic domain of the reproducing layer. On the other hand, a state is given in the area 31B disposed on the left side of the retransferred magnetic domain 31, in which the exchange coupling can be formed by the retransferred magnetic domain 31 and the magnetic domain of the reproducing layer. However, no transfer can be effected, because the size of the transferred magnetic domain is too small. Therefore, no transferred magnetic domain appears, and hence no ghost signal appears as well. Further, as shown in FIG. 18(b), when the disk is further rotated and moved starting from the state shown in FIG. 18(a) (when the recording magnetic domain 25 is separated from the light spot), the portion disposed on the left side of the retransferred magnetic domain 31, which intends to effect the exchange coupling, has an increased areal size. Therefore, the transferred magnetic domain 23 appears in the reproducing layer. However, the magnetic domain 55 (magnetic domain on the side of the light spot), which is disposed on the right side of the transferred magnetic domain 23 of the reproducing layer, cannot be reversed, because the repulsive force of the magnetostatic energy is dominant at the interface 31A with respect to the intermediate layer 4. Therefore, no ghost signal appears as well.

In the case of DWDD, the magnetizations of the reproducing layer, the intermediate layer, and the recording layer are designed to be extremely small. Therefore, the repulsive force of the magnetostatic energy does not act between the reproducing layer and the intermediate layer unlike the present invention. The magnetic domain is retransferred to the reproducing layer with ease. Therefore, the domain wall on the high temperature side of the retransferred magnetic domain is displaced along the temperature gradient to generate the ghost signal. As for CARED, it has been reported in Annual Conference on Magnetics of Magnetics Society of Japan (2000) that GdFeCr, which has small Ku, is preferred for the intermediate layer, and the characteristics are not improved with TbFeCoSi, as a result of the optimization of the intermediate layer. However, according to the present invention, a results has been obtained, in which no ghost signal appears when TbGdFe is used for the intermediate layer. In relation to this fact, when the non-magnetic area of the intermediate layer revives again in the low temperature portion from the high temperature portion, the magnetization is directed in the in-plane direction so as not to be antagonistic to the attracting force of the exchange energy and the repulsive force of the magnetostatic energy of the reproducing layer so that the forces are decreased, because Ku of GdFeCr is only about 2×10⁵ erg/cm³. Therefore, the magnetic domain of the recording layer is easily transferred to the reproducing layer by the aid of the attracting force of the exchange energy, and the ghost signal is generated. However, Ku of TbGdFe used in the eighth embodiment as described later on is large, i.e., 7×10⁵ erg/cm³. Therefore, it is considered that the retransfer from the intermediate layer to the reproducing layer is not permitted with ease, and hence no ghost signal appears. Further, the following fact is affirmed when the magneto-optical Kerr effect is investigated by allowing the light beam to come into the magneto-optical disk from the side of the film surface. That is, in the case of the magneto-optical disk based on the use of GdFeCr for the intermediate layer, the Kerr hysteresis loop is shifted to any one of the left and the right, and the sudden transition, which is inherent in the perpendicularly magnetizable film, is not exhibited. However, in the case of the magneto-optical disk based on the use of TbGdFe for the intermediate layer, the sudden transition is exhibited at the portion which is shifted with respect to the external magnetic field. Therefore, the method as described above can be used as the method for investigating the influence exerted by Ku of the intermediate layer.

The magneto-optical recording medium of the second type has been explained as exemplified by the use of the TM rich rare earth transition metal for the intermediate layer 4 in accordance with the expression (1) described above. However, the magnetostatic repulsive force may be established between the expanding reproducing layer 3 and the recording layer 5. That is, the intermediate layer may be RE rich in accordance with the expression (2) described above. FIG. 47 shows a state in which the intermediate layer is RE rich at a temperature in the vicinity of the reproducing temperature (120° C. to 160° C.). In this case, the following fact is appreciated. That is, the spins of the transition metals of the expanding reproducing layer 3, the intermediate layer 4, and the recording layer 5 are directed in the same direction (upward direction) by the aid of the exchange coupling force in a state in which the recording magnetic domain 5A approaches the light spot. The magnetostatic repulsive force is generated between the magnetic domain 4A of the intermediate layer 4 and the magnetic domain 5A of the recording layer 5. When the disk is further rotated to make the approach to the light spot, then the exchange coupling force between the magnetic domain 4B adjacent to the magnetic domain 4A and the magnetic domain 5B disposed just thereunder is weakened for the magnetic domain 4B as shown in FIG. 48, and the magnetostatic repulsive force between the magnetic domains overcomes the exchange coupling force. Therefore, the magnetic domain 4B of the intermediate layer is reversed. Based on this opportunity, the magnetic domain 3B of the expanding reproducing layer, which has been transferred by the exchange coupling force with respect to the magnetic domain 4B, is reversed as well. The reversal of the magnetic domain 3B corresponds to the start of the expansion of the magnetic domain 3A. The magnetic domain 3A is further expanded thereafter until arrival at the minimum magnetic domain diameter. The effect of the magnetic domain expansion reproduction of the present invention is obtained even when the magnetostatic repulsive force exists between the expanding reproducing layer 3 and the recording layer 5, i.e., when the expression (2) described above holds. The expression (2) described above is also applicable to the magneto-optical recording medium of the first type described above and the magneto-optical recording medium of the third type described below.

Magneto-Optical Recording Medium of Third Type

The magneto-optical recording medium of the third type includes the substance which is different from the substance for constructing the intermediate layer and which is allowed to intervene at the interface between the intermediate layer and the recording layer or at the interface between the intermediate layer and the expanding reproducing layer. The substance lowers the Curie temperature of the intermediate layer at each of the interfaces, or the Curie temperature of the substance itself is lower than the Curie temperature of the intermediate layer. When the magneto-optical recording medium includes the substance as described above which is disposed at the surface of the intermediate layer or at the interface between the intermediate layer and the recording layer or the expanding reproducing layer, the exchange coupling force between the recording layer and the expanding reproducing layer is cut off at the reproducing temperature. In order to introduce the substance as described above, the intermediate layer or the interface thereof may be subjected to the sputtering, the ion etching, or the heat treatment. Alternatively, a layer, which is composed of a substance having a low Curie temperature, for example, a rare earth element or nickel, may be deposited at the interface between the recording layer and the intermediate layer or at the interface between the expanding reproducing layer and the intermediate layer, for example, with the vapor phase method.

In the case of the magneto-optical recording medium of the third type, any magnetization may remain in the intermediate layer 4 at a temperature of not less than the reproducing temperature. That is, the Curie temperature of the material for the intermediate layer 4 may be not less than the reproducing temperature, especially not less than 160° C. Therefore, in the case of the magneto-optical recording medium of the third type, the Curie temperature of the intermediate layer may be set to be higher than the Curie temperature of the expanding reproducing layer, in the same manner as in the magneto-optical recording medium of the first type.

In order to more easily expand the magnetic domain transferred to the reproducing layer in each of the magneto-optical recording media of the first to third types, it is desirable that the magnetization of the reproducing layer is decreased to some extent. For example, it is preferable that the saturation magnetization of the reproducing layer is not more than 80 emu/cm³ at a temperature of 120° C. Further, in order to avoid the appearance of the ghost signal, it is preferable that the saturation magnetization of the reproducing layer is not less than 40 emu/cm³ at a temperature in the vicinity of 120° C.

It is preferable that the magneto-optical recording media of the first to third types are designed so that the attracting force of the exchange energy (exchange coupling force) as shown in FIG. 15(b) is suddenly decreased at the boundary between the reproducing temperature area and the low temperature area. Accordingly, even when the minute magnetic domain transferred to the reproducing layer is expanded by the displacement, toward the center of the light spot, of the domain wall disposed at the central portion of the light spot, of the minute magnetic domain transferred to the reproducing layer, the domain wall of the minute magnetic domain, which is disposed on the side opposite to the center of the light spot, is fixed without causing any displacement (see the front edge 3AF and the rear edge 3AR shown in FIG. 6). Therefore, it is possible to perform the expanding reproduction more stably. In order to steepen the slope of the curve of the attracting force of the exchange-energy shown in FIG. 15(b) at the boundary between the reproducing temperature area and the low temperature area, for example, the perpendicular magnetic anisotropy energy of the intermediate layer at room temperature may be not less than 0.4×10⁶ erg/cm³.

In the present invention, especially in the magneto-optical recording medium of the second type, it is preferable that the magnetization of the intermediate layer is large to some extent. It is preferable that the saturation magnetization at temperatures in the vicinity of 100° C. is not less than 50 emu/cm³. Accordingly, it is possible to obtain the repulsive force of the magnetostatic energy suitable for easily expanding the transferred magnetic domain of the reproducing layer. Further, it is possible to avoid the appearance of the ghost signal which would be otherwise caused in DWDD and CARED. As for the material having the characteristic as described above, for example, it is preferable to use a TbGdFe alloy which contains Gd in a ratio of not more than ⅕ with respect to Tb. A non-magnetic metal may be added in place of the slight amount of Gd. If the Curie temperature of the intermediate layer is too high in the magneto-optical recording medium of the second type, it is feared that the magnetic domain expansion signal obtained from the reproducing layer may be decreased when information is reproduced. Therefore, it is preferable that the Curie temperature of the intermediate layer is not more than 160° C.

In order to obtain the appropriate repulsive force of the magnetostatic energy as shown in FIG. 15(b), it is preferable that the saturation magnetization of the recording layer is not less than 50 emu/cm³ within a temperature range of 150° C. to 200° C.

In the magneto-optical recording medium of the present invention, the reproducing layer is the perpendicularly magnetizable film within a temperature range from 20° C. to a temperature in the vicinity of the Curie temperature. Therefore, the ghost signal is effectively avoided, which would be otherwise caused by retransferring the magnetic domain of the recording layer to the reproducing layer again. It is most appropriate for the reproducing layer as described above to use a GdFe alloy including, for example, GdFe and GdFeCo.

It is preferable that the recording layer of the magneto-optical recording medium of the present invention is formed as a film at a gas pressure of not less than 0.4 Pa by using a sputtering gas which is mainly composed of argon. Magnetic grains are fine and minute in the recording layer formed at the gas pressure of not less than 0.4 Pa. Therefore, fine reversed magnetic domain are capable of existing in the recording layer, and thus it is possible to reliably form the minute magnetic domains.

In order to form the minute magnetic domains in the recording layer, it is preferable to reduce the influence of the leak magnetic field originating from the magnetic layer or layers other than the recording layer during the recording of information. For this purpose, for example, it is recommended that the Curie temperature of the reproducing layer is lower than the Curie temperature of the recording layer by not less than 30° C. Accordingly, the magnetization of the reproducing layer is extinguished or decreased by being heated by radiating the recording laser beam during the recording of information. Therefore, it is possible to avoid or reduce the application of the leak magnetic field to the recording layer. In order to successfully form the minute magnetic domains in the recording layer, the recording layer may be mixed with, for example, a metal mainly composed of noble metal such as Pt, Pd, Au, and Ag, or a cluster having a grain diameter of not more than 20 nm composed of a dielectric such as SiO₂ at a concentration of not more than 30%. If the concentration of the substance to be mixed with the recording layer exceeds 30%, it is feared that the magnetization and the perpendicular magnetic anisotropy energy may be decreased to deteriorate the recording performance. Therefore, the concentration is preferably not more than 30%. When the recording layer as described above is subjected to AC demagnetization at a temperature in the vicinity of 150° C., then the magnetic domain diameter is not more than 50 nm, and it is easy to perform the recording with magnetic domains of not more than 100 nm.

In order to record finer minute magnetic domains in the recording layer, it is preferable to utilize a magnetic multilayer film for a part of or all of the recording layer. The magnetic multilayer film is obtained by alternately stacking not less than 5 and not more than 40 sets of, for example, a magnetic layer of not more than 0.4 nm mainly composed of Co, and a metal layer having a thickness of not more than 1.2 nm and preferably not more than 0.8 nm mainly composed of Pd or Pt. The magnetic multilayer film as described above has the perpendicular magnetic anisotropy energy which is larger than that of a single layer of TbFeCo by as much as twice or more. The recording layer, in which the perpendicular magnetic anisotropy energy is large, makes it possible to stably store the minute magnetic domains to be formed over a long period of time. The large perpendicular magnetic anisotropy energy of the magnetic multilayer film differs depending on the state of an underlying base or underlayer disposed under the magnetic multilayer film. When the magnetic multilayer film is used for the recording layer, it is preferable to establish such a state that clusters, which have grain diameters of not more than 20 nm and which comprise a metal mainly composed of a noble metal such as Pt, Pd, Au, and Ag or a dielectric such as SiO₂, are mixed with the underlayer and the grain diameters are not more than 20 nm. In order to record the fine minute magnetic domains in the recording layer, a part of or all of the recording layer may be formed of a localized compound alloy which is mainly composed of Co and Pd or Pt. Alternatively, a metal layer mainly composed of noble metal such as Pt, Pd, Au, and Ag, or a layer having clusters of grain diameters of not more than 50 nm composed of a dielectric such as SiO₂ mixed therewith by not less than 10% as represented by an atomic weight ratio may be formed to have a thickness of not less than 20 nm in contact with the information-recording layer on the side opposite to the magnetic domain-expanding reproducing layer.

When the recording and the reproduction are performed at a high resolution by using the magneto-optical recording medium of the present invention, the following feature appears in the reproduced waveform. For example, a reproduced waveform, which is obtained when an isolated magnetic domain is subjected to reproduction with a reproducing power that is ½ of Pr, has a signal intensity that is not more than ½ of A and a half value width that is not less than twice B, as compared with a signal intensity A and a half value width B of a reproduced waveform which is obtained when the isolated magnetic domain having a length of 0.2 (or 0.1)×L is subjected to recording at a cycle L with a reproducing power (Pr) capable of obtaining a maximum signal-to-noise ratio (C/N) for a close-packed recording magnetic domain having a length of 0.2 (or 0.1)×L provided that a wavelength of a laser beam is λ, a numerical aperture of an objective lens is NA, and a length that is twice λ/NA is the cycle L. When the condition as described above is satisfied, it is possible to perform the recording and the reproduction at a high density in relation to both of the resolution and the reproduced signal intensity.

Those having been described above provide an extremely effective method to improve the density in the linear density direction. However, in order to enhance the density in the track direction, the following method is effective. For example, both of the land portion and the groove portion of the substrate are used as the recording areas, it is advantageous that the half value width of the groove is made wider than the half value width of the land, for the following reason. That is, the groove width is effectively narrowed by the film formation. Accordingly, it is possible to dissolve the difference in recording and reproducing characteristics between the land portion and the groove portion. Alternatively, information may be recorded on any one of the land and the groove. In this procedure, the areal size of one of them subjected to the recording of information can be made smaller than that of the other.

In the case of the magneto-optical recording medium of the present invention, it is unnecessary to use the deep groove land-groove substrate unlike the DWDD medium. It is possible to use known or existing substrates.

When the recording and the reproduction are performed by alloying the light beam to come into the magneto-optical recording medium of the present invention from the side of the substrate, the substrate to be used preferably has the following feature. That is, assuming that the refractive index thereof is represented by n, it is preferable that the height of the side wall of the land (or the depth of the groove) is λ/(16n) to λ/(5n) in view of the easiness of the formation of the substrate. When the recording and the reproduction are performed by alloying the light beam to come into the magneto-optical recording medium from the side opposite to the substrate, it is preferable that the height of the side wall of the land (or the depth of the groove) is λ/16 to λ/5.

In the present invention, as shown in FIG. 21, the half value width G of the groove (referring to the groove width at a depth of ½ of the groove depth D) formed on the substrate of the magneto-optical recording medium may be larger than the half value width L of the land (refereeing to the land width at a depth of ½ of the groove depth D). The recording and reproducing power sensitivities can be improved by recording information on the groove portion. According to an experiment performed by the present inventors, it has been revealed that the recording and reproducing power sensitivity differs between the medium based on the land recording system and the medium based on the groove recording system. It is considered that the behavior of the heat flow differs between the land portion and the groove portion during the recording and the reproduction resulting from the shape of the substrate, the heat tends to be released especially from the land portion, and hence the power sensitivity is lowered. In the present invention, it is desirable that a ratio (G/L) between the groove half value width (G) and the land half value width (L) of the magneto-optical recording medium satisfies 1.3≦(G/L)≦4.0. When G/L is maintained within this range, then the bit error rate can be reduced, and it is possible to obtain satisfactory C/N. Further, it is possible to secure a sufficient push-pull signal which is necessary for the tracking.

In the case of the G/L ratio as described above, it is desirable that the substrate groove depth (D) in the area formed with the groove and the land is 30 nm to 80 nm. When the reproducing groove depth is within this range, then it is possible to secure a push-pull signal which is sufficient to perform the tracking stably, and it is possible to form the layer such as the recording layer with a necessary thickness on the groove.

It is desirable that an angle of inclination (θ) of a side wall surface of the land is 40° to 75°. When the angle of inclination (θ) is within this range, then it is possible to avoid the deterioration of the reproduced signal which would be otherwise caused by the influence of the adjoining track, and it is possible to form the layer such as the recording layer with a necessary thickness on the groove.

According to the present invention, there is provided a reproducing method on the magneto-optical recording medium, comprising irradiating the magneto-optical recording medium of the present invention with a reproducing light beam to effect heating to a temperature not less than a temperature at which the exchange coupling force between the recording layer and the reproducing layer is cut off so that information is reproduced from the magneto-optical recording medium. When this method is used, the magnetic domain, which is transferred to the reproducing layer, can be reliably expanded and detected without generating any ghost signal. Therefore, a large reproduced signal is obtained at a high C/N level. According to this method, the recording magnetic domain can be detected before the recording magnetic domain intended to be reproduced arrives at the center of the reproducing light beam. Further, according to this method, it is unnecessary to apply any external magnetic field to the magneto-optical recording medium during the reproduction of information.

According to the present invention, there is provided a magneto-optical recording and reproducing apparatus for performing magnetic modulation recording on the magneto-optical recording medium of the present invention.

The magneto-optical recording and reproducing apparatus of the present invention makes it possible to effect the overwrite on the magneto-optical recording medium of the present invention. Information can be recorded in accordance with the magnetic field modulation recording system which is excellent to perform the high density recording. The recording and reproducing apparatus makes it possible to record information on the magneto-optical recording medium in accordance with the light pulse magnetic field modulation recording system. In the case of the light pulse magnetic field modulation recording system, the recording with minute magnetic domains can be successfully performed at a pulse duty of 25% to 45%, for the following reason. That is, the high speed heat response is required. In the case of the magneto-optical recording medium of the present invention, the fluctuation of the DC component of the reproduced signal is relatively large. In order to supplement the fluctuation of the DC component, the recording and reproducing apparatus of the present invention may further comprise a signal processing unit which cuts lowpass signals by using a filter of lowpass removal of not more than 100 kHz, differential detection, or difference detection. Further, in order to realize the stable magnetic domain expansion reproduction, it is necessary to use a trigger which actively induces the magnetic domain expansion. This can be realized by effecting the radiation by modulating the reproducing light beam power without using any constant value. More preferably, the following apparatus may be used. That is, a reference clock is previously embedded on the substrate to prepare a precise clock with a PLL circuit so that the synchronization accuracy is enhanced for the recording and the reproduction. Other effective methods for generating the trigger include a method in which the reproducing magnetic field is applied and a method in which the reproducing magnetic field is applied while effecting the modulation without using any constant value. Also in this case, it is preferable to perform the correct synchronized reproduction for the recording and the reproduction by using clock pits embedded in the substrate.

### BRIEF DESCRIPTION OF THE DRAWINGS

FIG. 1 illustrates the principle of expansion of a magnetic domain in a reproducing layer (FIGS. 1(a) to 1(d)).

FIG. 2 illustrates the exchange coupling force and the repulsive force generated between an information-recording layer and an expanding reproducing layer, wherein FIG. 2(a) shows a magnetic characteristic to satisfy the expression (1), and FIG. 2(b) shows a magnetic characteristic to satisfy the expression (2).

FIG. 3 illustrate the principle of reproduction on the magneto-optical recording medium of the first type.

FIG. 4 illustrate the principle of reproduction on the magneto-optical recording medium of the first type.

FIG. 5 illustrate the principle of reproduction on the magneto-optical recording medium of the first type.

FIG. 6 illustrate the principle of reproduction on the magneto-optical recording medium of the first type.

FIG. 7 illustrate the principle of reproduction on the magneto-optical recording medium of the first type.

FIG. 8 illustrate the principle of reproduction on the magneto-optical recording medium of the first type.

FIG. 9 illustrate the principle of reproduction on the magneto-optical recording medium of the first type.

FIG. 10 illustrate the principle of reproduction on the magneto-optical recording medium of the first type.

FIG. 11 illustrate the principle of reproduction on the magneto-optical recording medium of the first type.

FIG. 12 illustrate the principle of reproduction on the magneto-optical recording medium of the first type.

FIG. 13 illustrate the principle of reproduction on the magneto-optical recording medium of the second type, depicting situations of magnetizations of a reproducing layer 3, an intermediate layer 4, and a recording layer 5 before being irradiated with a reproducing light beam.

FIG. 14 illustrates the principle of magnetic domain expansion in the magneto-optical recording medium of the second type, wherein FIG. 14(a) shows a situation in which the reproducing light beam is radiated, FIG. 14(b) shows a situation in which a magnetic domain of the recording layer is expanded starting from the state shown in FIG. 14(a), and FIG. 14(c) shows a situation in which a magnetic domain of the recording layer is shrunk starting from the state shown in FIG. 14(a).

FIGS. 15(a) and 15(b) show the relationship between the repulsive force of the magnetostatic energy and the attracting force of the exchange energy when the magnetic domain of the reproducing layer is not expanded.

FIGS. 16(a) and 16(b) illustrate situations in which the magnetic domain of the reproducing layer of the magneto-optical recording medium of the second type is expanded.

FIGS. 17(a) and 17(b) illustrate situations of the magnetic domain expansion in the reproducing layer when the perpendicular magnetic anisotropy of the intermediate layer of the magneto-optical recording medium of the second type is small.

FIGS. 18(a) and 18(b) illustrate the reason why any ghost signal is not generated on the magneto-optical recording medium of the second type.

FIG. 19 illustrates the absence of the influence of the leak magnetic field to be received from the recording magnetic domain in the area of the expanding reproducing layer in which the magnetic domain is expanded.

FIG. 20 shows a schematic sectional view illustrating a magneto-optical recording medium produced in a first embodiment.

FIG. 21 schematically shows the cross-sectional shapes of the land and the groove of each of magneto-optical recording media manufactured in the first embodiment, tenth to thirteenth embodiments, Comparative Example, and Reference Example.

FIG. 22 shows a graph illustrating a reproduced signal waveform obtained when the magneto-optical disk produced in the first embodiment was subjected to reproduction with different reproducing light beam powers.

FIG. 23 shows a graph illustrating the dependency of the bit error rate on the reproducing light beam power obtained when the magneto-optical disk produced in the first embodiment was subjected to reproduction.

FIG. 24 shows a graph illustrating the dependency of the bit error rate on the recording light beam power obtained when the magneto-optical disk produced in the first embodiment was subjected to recording with various recording light beam powers.

FIG. 25 shows a graph illustrating a hysteresis loop for determining the exchange coupling force of the magneto-optical disk produced in the first embodiment.

FIG. 26 shows a graph illustrating the temperature dependency of the exchange coupling force of the magneto-optical disk produced in the first embodiment.

FIG. 27 shows a graph illustrating the relationship of the bit error rate with respect to (thickness t of expanding reproducing layer x saturation magnetization Ms) of the magneto-optical disk produced in the first embodiment.

FIG. 28 shows a graph illustrating the relationship of the bit error rate with respect to the groove depth D of the substrate of the magneto-optical disk produced in the first embodiment.

FIG. 29 shows a graph illustrating the relationship of the bit error rate with respect to the G/L ratio of the substrate of the magneto-optical disk produced in the first embodiment.

FIG. 30 shows a graph illustrating the relationship of the bit error rate with respect to the angle of inclination θ of the land side wall of the substrate of the magneto-optical disk produced in the first embodiment.

FIG. 31 shows a graph illustrating the relationship between the thickness t of an expanding reproducing layer and the bit error rate of a magneto-optical disk produced in a second embodiment.

FIG. 32 shows a schematic sectional view illustrating a magneto-optical recording medium manufactured in an eighth embodiment.

FIG. 33 shows reproduced waveforms obtained by reproducing isolated magnetic domains each having a mark length of 0.2 μm recorded in the magneto-optical recording medium of the eighth embodiment with reproducing powers of 1.5 mW and 3.0 mW.

FIG. 34 shows a graph illustrating the dependency of the mark length on C/N of the magneto-optical recording medium of the eighth embodiment.

FIG. 35 shows an eye pattern obtained when an NRZI random signal having a shortest mark length of 0.12 μm was recorded.

FIG. 36 shows a schematic arrangement of a recording and reproducing apparatus according to the present invention.

FIG. 37 shows a schematic sectional view illustrating the magneto-optical recording medium manufactured in each of the tenth to twelfth embodiments, Comparative Example, and Reference Example.

FIG. 38 shows a graph illustrating the relationship between the bit error rate and the ratio G/L between the groove half value width G and the land half value width L in the tenth embodiment.

FIG. 39 shows a graph illustrating the relationship between the bit error rate and the groove depth D in the eleventh embodiment.

FIG. 40 shows a graph illustrating the relationship between the bit error rate and the angle of inclination θ of the land side wall surface in the twelfth embodiment.

FIG. 41 shows a graph illustrating the relationship between the bit error rate and the recording power in Comparative Example and Reference Example.

FIG. 42 shows a graph illustrating the relationship between the bit error rate and the reproducing power in Comparative Example and Reference Example.

FIG. 43 shows a schematic sectional view illustrating a structure of a magneto-optical disk of a thirteenth embodiment.

FIG. 44 shows a graph illustrating the exchange coupling force cutoff temperature.

FIG. 45 shows a graph illustrating the relationship between the temperature gradient of the exchange coupling force and the bit error rate.

FIG. 46 shows a hysteresis curve of the magneto-optical disk of the present invention at a temperature in the vicinity of 120° C.

FIG. 47 conceptually illustrates the principle of reproduction on the magneto-optical recording medium of the second type in which the expression (2) holds.

FIG. 48 shows a state in which the magneto-optical disk is moved with respect to the light spot starting from the state shown in FIG. 47.

FIG. 49 illustrates the principle of the FAD magnetic super resolution technique.

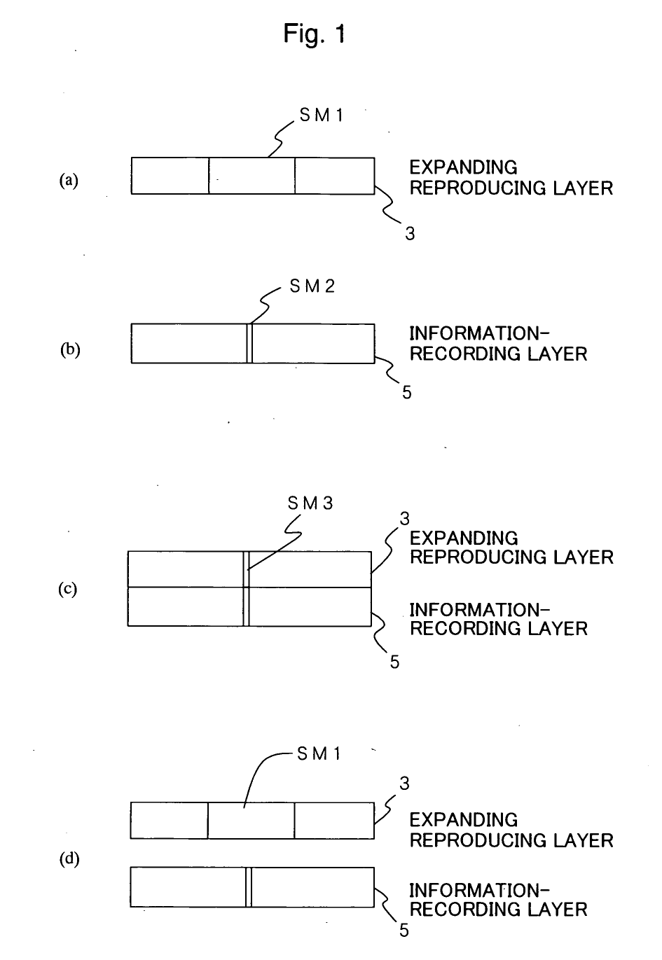

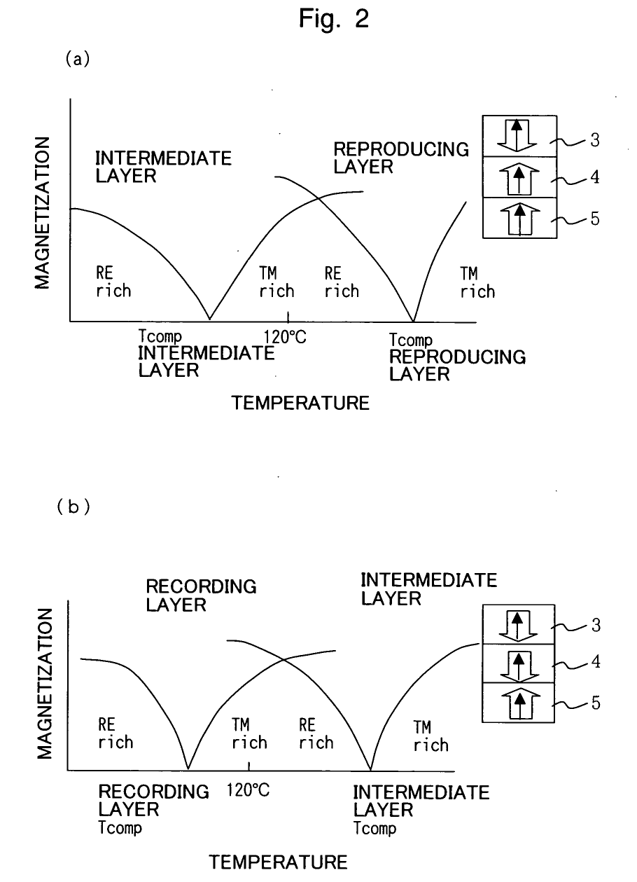

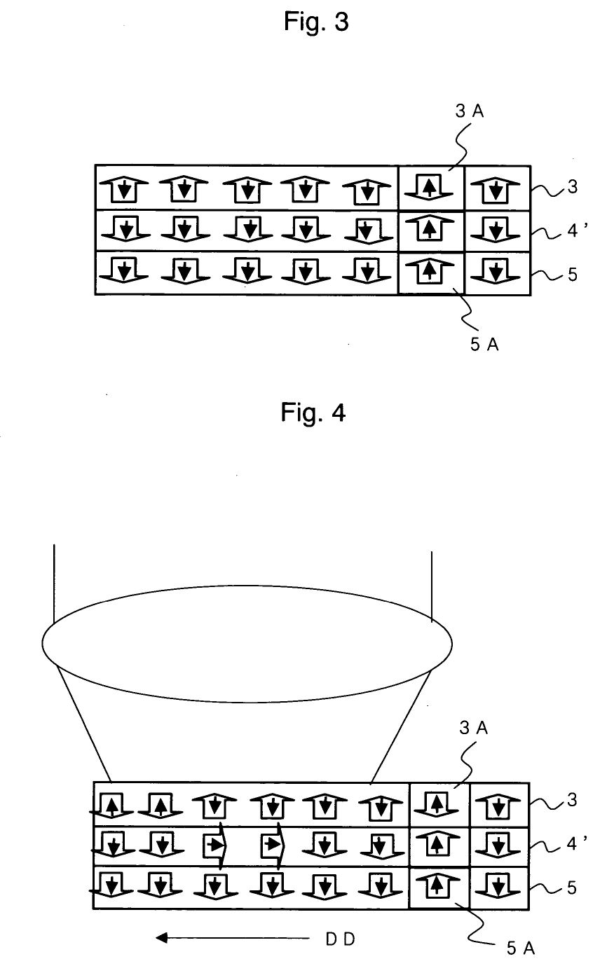

### BEST MODE FOR CARRYING OUT THE INVENTION

An explanation will be specifically made below about embodiments of the magneto-optical recording medium according to the present invention, the reproducing method thereon, and the recording and reproducing apparatus therefor. However, the present invention is not limited thereto.

### FIRST EMBODIMENT

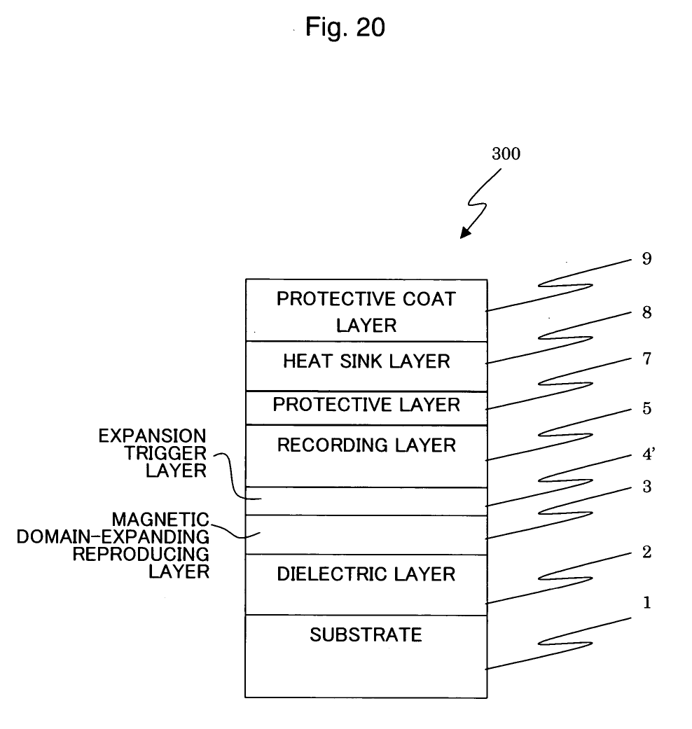

In this embodiment, a magneto-optical disk 300 having a structure as shown in FIG. 20 is produced. The magneto-optical disk 300 corresponds to the magneto-optical recording medium of the first type of the present invention. The magneto-optical disk 300 comprises, on a substrate 1, a dielectric layer 2, an expanding reproducing layer (magnetic domain-expanding reproducing layer) 3, an expansion trigger layer 4′, a recording layer 5, a protective layer 7, a heat sink layer 8, and a protective coat layer 9. The magneto-optical recording medium 300 as described above was manufactured as follows by using a high frequency sputtering apparatus.

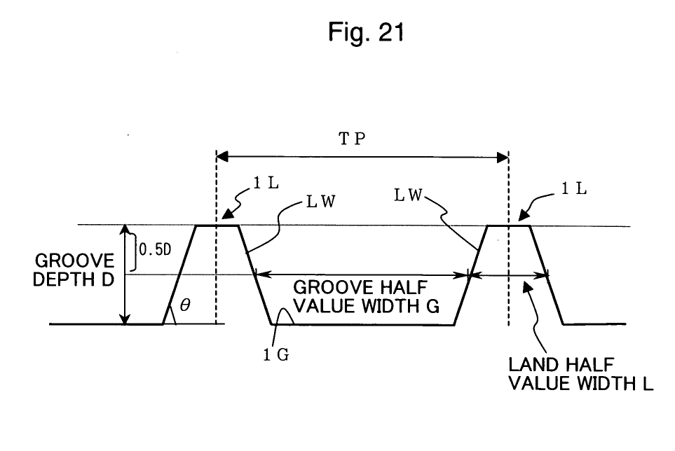

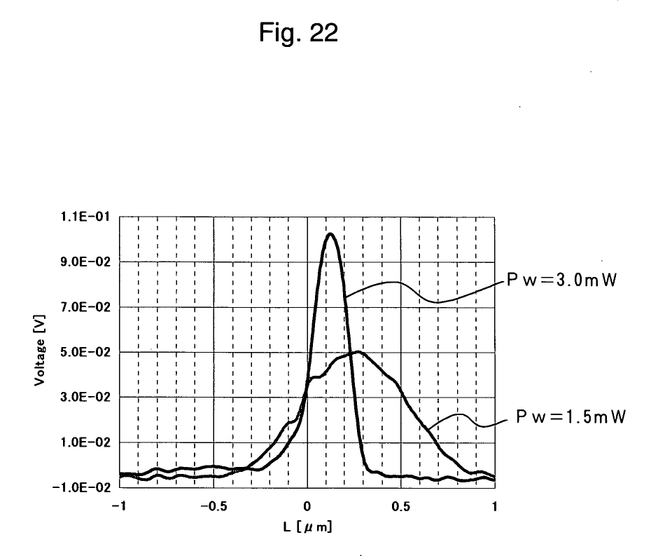

A polycarbonate substrate having a shape as shown in FIG. 21 was used for the substrate 1. The substrate 1 had a track pitch TP=700 nm, a land half value width L=200 nm, a groove half value width G=500 nm, a groove depth D=60 nm, and a thickness of 0.6 mm. The land half value width L and the groove half value width G mean the widths of the land and the groove at depth positions at which the groove depth D is D/2 respectively. The angle of inclination θ of the land side wall (or the angle of inclination of the groove) was about 65°. The substrate 1 was installed to a substrate holder disposed in a film formation chamber of the high frequency sputtering apparatus, and the film formation chamber was evacuated until arrival at an attained degree of vacuum of 1.0×10⁻⁵ Pa. After that, a film of SiN was formed to have a film thickness of 60 nm as the dielectric layer 2 on the substrate 1.

Subsequently, a film of a rare earth-rich GdFeCo amorphous alloy was formed to have a film thickness of 20 nm as the expanding reproducing layer 3 on the dielectric layer 2. The GdFeCo amorphous alloy had a Curie temperature of about 230° C. and a compensation temperature of not less than the Curie temperature. The saturation magnetization at 160° C. was about 30 emu/cm³. When the film of the expanding reproducing layer 3 was formed, the sputtering gas pressure was adjusted to be 0.3 Pa. Subsequently, a transition metal-rich TbGdFeCo amorphous alloy layer was formed to have a film thickness of 10 nm as the expansion trigger layer 4′ on the expanding reproducing layer 3. The TbGdFeCo amorphous alloy had a Curie temperature of about 240° C. and a compensation temperature of not more than room temperature. The expansion trigger layer 4′ exhibits the perpendicular magnetization at temperatures from room temperature to about 120° C. The in-plane magnetization component is increased from about 140° C. to exhibit the in-plane magnetization until arrival at the Curie temperature.

Subsequently, a TbFeCo amorphous alloy was formed to have a film thickness of 60 nm as the recording layer 5 on the expansion trigger layer 4′. The amount of Co contained in the recording layer 5 was larger than the amount of Co contained in the expansion trigger layer. The TbFeCo amorphous alloy had a Curie temperature of about 270° C. and a compensation temperature of about 80° C. When the film of the recording layer 5 was formed, the sputtering gas pressure was 1 Pa. The reason why the sputtering gas pressure during the film formation of the recording layer is not less than twice the sputtering gas pressure during the film formation of the expanding reproducing layer is that it is intended to increase the recording density by raising the sputtering gas pressure so that minute magnetic domains are formed with ease. It is preferable that the sputtering gas pressure during the film formation of the recording layer is not less than 0.4 Pa. On the other hand, as for the expanding reproducing layer, it is preferable that the sputtering gas pressure is not increased so much in order to increase the minimum magnetic domain diameter.

Subsequently, a film of SiN was formed to have a film thickness of 20 nm as the protective layer 7 on the recording layer 5. A film of Al was formed to have a film thickness of 30 nm as the heat sink layer 8 on the protective layer 7. After that, the disk was taken out from the sputtering apparatus. The disk was spin-coated with an ultraviolet-curable resin to have a thickness of about 5 μm, and the resin was cured by being irradiated with ultraviolet light. Thus, the magneto-optical disk 300 having the stacked structure shown in FIG. 20 was obtained.

The performance of the magneto-optical disk 300 obtained as described above was evaluated as follows. A commercially available tester, which carried an optical head having a wavelength of 650 nm and a numerical aperture NA=0.60 of an objective lens, was used for the evaluation. A light beam, which was radiated from the optical head, had a light spot diameter of about 1 μm on the magneto-optical disk. The disk was rotated so that the linear velocity of the disk was 3.5 to 5.0 m/sec. At first, magnetic domains, each of which had a diameter of 0.2 μm corresponding to ⅕ of the light spot diameter, were formed in the recording layer by the light pulse magnetic field modulation recording. In this procedure, the recording clock cycle was 40 nsec, the light pulse width was 18 nsec, and the recording laser power was about 10 mW on the disk recording surface. A positive magnetic field of +300 Oe having a pulse width of 40 nsec and a negative magnetic field of −300 Oe having a pulse width of 360 nsec were repeatedly applied in combination as the recording magnetic field while radiating the light pulse onto the magneto-optical disk. Therefore, the following recording magnetic domain lengths were obtained, for example, on condition that the plus magnetic field was directed in the recording direction (solid magnetic domain formation) and the minus direction was the erasing direction (blank magnetic domain). That is, the solid magnetic domain was formed to have a length of 200 nm, and the blank magnetic domain was formed to have a length of 1800 nm.

A repeated recording pattern, which was formed on the magneto-optical disk as described above, was reproduced by radiating the reproducing light beam. The reproducing light beam was a continuous light beam. When the reproducing light beam had a power Pw=1.5 mW, the repeated recording pattern was successfully observed as a waveform as shown in FIG. 22, although the repeated recording pattern had a slight signal intensity. The light spot diameter was about 1 μm. Therefore, it is appreciated that the length of the lower slope of the reproduced signal waveform of the recording magnetic domain of 0.2 μm is 1 μm+0.2 μm, i.e., 1.2 μm. The half value width was about 0.6 μm. Subsequently, when the reproducing light beam power was changed to 3.0 mW to reproduce the repeated recording pattern, a reproduced waveform as shown in FIG. 22 was obtained. As appreciated from FIG. 22, the half value width was 0.2 μm which was the same as the length of the recording magnetic domain. It is appreciated that the half value width is narrowed to be about ⅓ of that obtained when the reproducing light beam power was 1.5 mW. On the other hand, the reproduced signal intensity is increased not less than twice as compared with that obtained when the reproducing light beam power is 1.5 mW. According to the reproduced signal waveforms shown in FIG. 22, it is understood that the recording magnetic domains are transferred to the recording layer, and they are expanded and reproduced when the reproducing light beam power is 3.0 mW. On the other hand, the expansion does not occur when the reproducing light beam power is 1.5 mW. In this case, it is considered that the recording magnetic domains, which are transferred to the reproducing layer, are reproduced as they are.

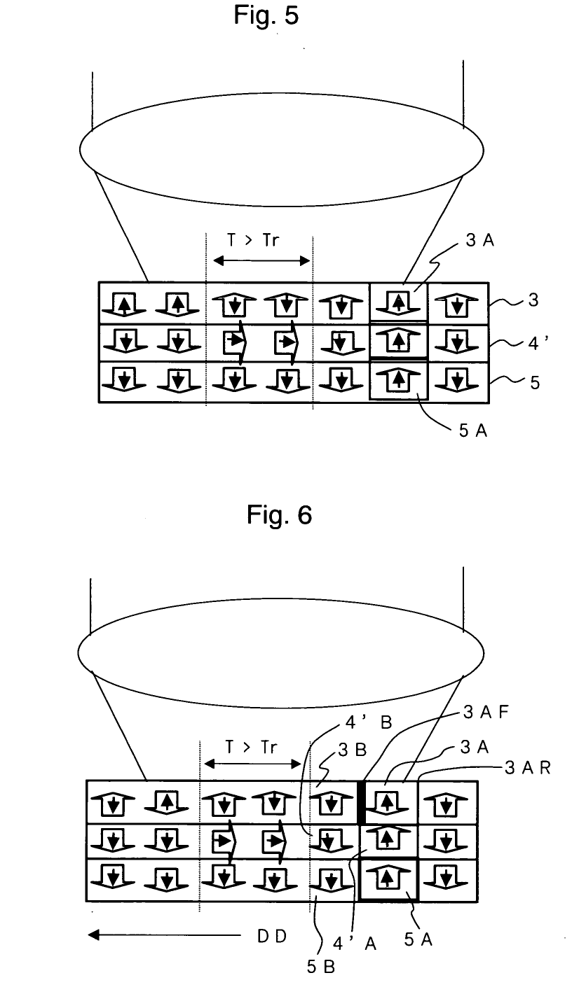

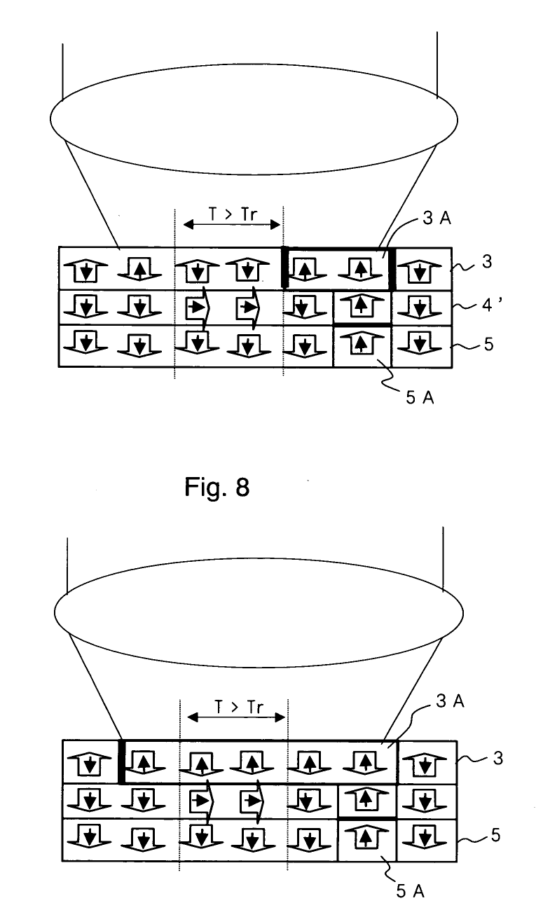

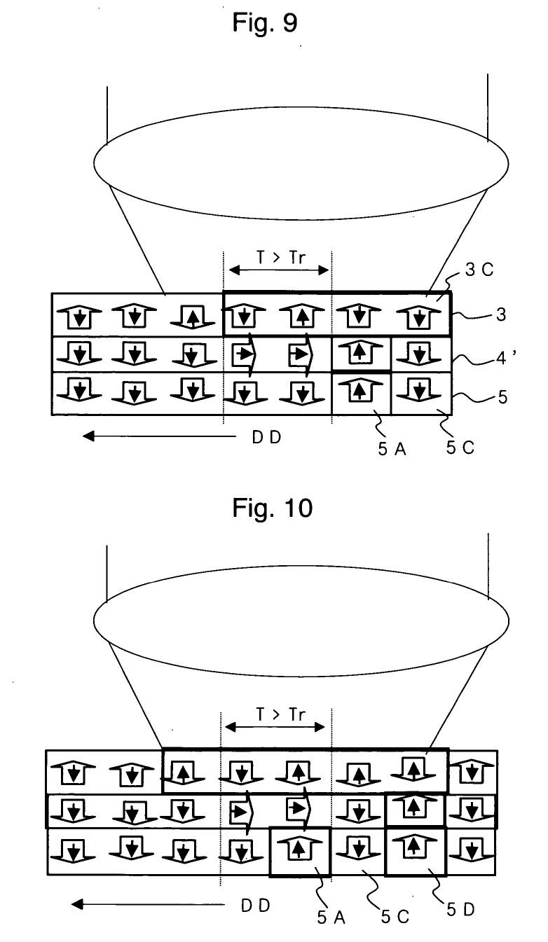

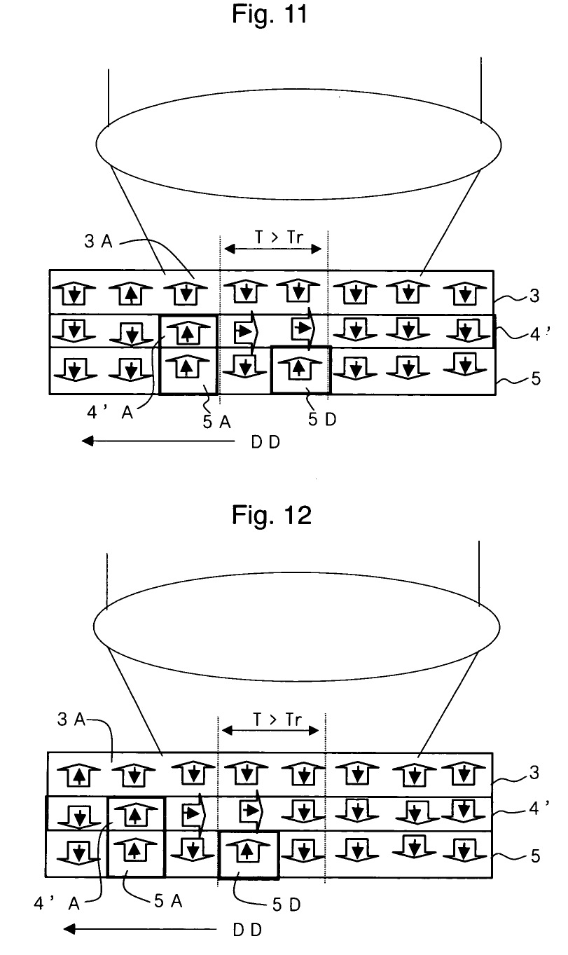

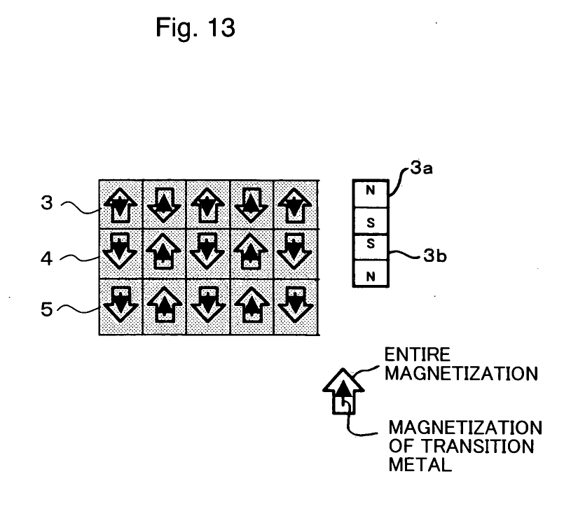

Further, the following important fact is appreciated when the waveforms shown in FIG. 22 are compared with each other. The center of the peak obtained when the reproducing light beam power is 3.0 mW appears temporally earlier than the center of the peak obtained when the reproducing light beam power is 1.5 mW. That is, when the expansion of the magnetic domain transferred to the reproducing layer occurs, the magnetic domain can be detected before the transferred magnetic domain arrives at the center of the light spot. This fact will be also appreciated from the explanation of the theory, i.e., the recording magnetic domain 5A, which is about to enter the light spot, is transferred to the expanding reproducing layer 3, and it is expanded in the light spot as shown in FIG. 5. The temporally advanced detection of the recording magnetic domain with respect to the center of the light spot is a great feature of the reproducing method based on the use of the magneto-optical recording medium of the present invention.

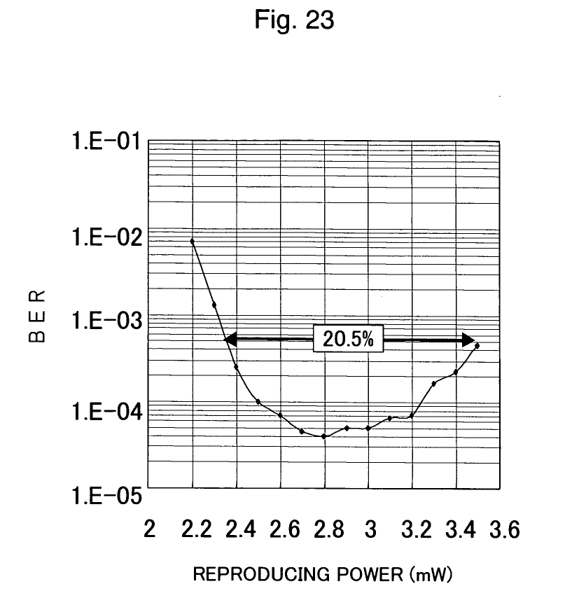

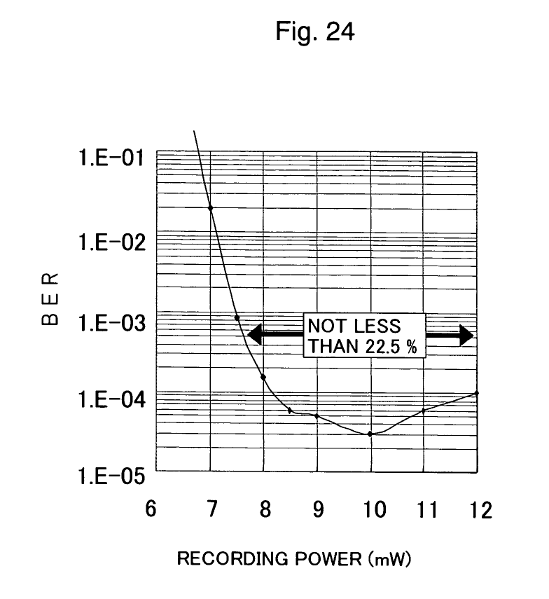

Subsequently, an NRZI random pattern having a shortest mark length of 0.12 μm corresponding to about 1/10 of the light spot diameter was recorded, and the pattern was reproduced with a variety of reproducing light beam powers. The dependency of the error rate on the reproducing power was measured from the reproduced signal. An obtained result is shown in FIG. 23. If one error appears when 5000 pieces of data are recorded, the error rate is 5×10⁻⁴, in which the data correction can be practically performed. According to FIG. 23, it is appreciated that the reproducing power margin, which satisfies an error rate of not more than 5×10⁻⁴, is 20.5% which realizes a degree of not less than ±10%. Therefore, it may be affirmed that the magneto-optical disk of the present invention is a sufficiently practically usable medium in relation to the reproducing power margin. Subsequently, the recording power was changed to record the NRZI random pattern having the shortest mark length of 0.12 μm, and the error rate was determined when the recorded information was reproduced. FIG. 24 shows the change of the error rate with respect to the recording power. It has been revealed that the error rate of not more than 5×10⁻⁴ can be secured even when the recording power is changed by not less than ±10% (not less than 22.5%) in the same manner as the reproducing power. Therefore, the magneto-optical disk of the present invention also satisfies the recording power margin. Further, the decrease of the effective laser power was observed with respect to the inclination of the magneto-optical disk. As a result, it was revealed that a target for the practical use, i.e., ±0.6° was satisfied.

### SECOND EMBODIMENT

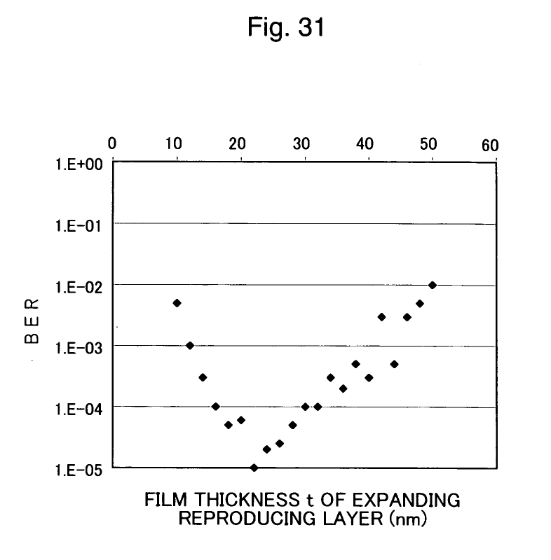

A plurality of magneto-optical disk samples were produced in the same manner as in the first embodiment except that-the expanding reproducing layer 3 of the magneto-optical disk was changed to have a variety of film thicknesses of 10 to 50 nm. The bit error rate (BER) was measured for the magneto-optical disks in the same manner as in the first embodiment. FIG. 31 shows the relationship between the measured bit error rate and the various film thicknesses t of the expanding reproducing layers 3. According to FIG. 31, it is appreciated that a bit error rate of 1×10⁻⁴ is achieved within a range of 15 to 30 nm of the film thickness t of the expanding reproducing layer 3. The reason of this result is considered as follows. That is, if the film thickness of the expanding reproducing layer 3 is thinner than the above, it is difficult to correctly reproduce the signal, because the recording magnetic domains of the expansion trigger layer and the recording layer are visible or readable through the reproducing layer. On the other hand, if the film thickness of the expanding reproducing layer 3 is thicker than 30 nm, then it is difficult to magnetically transfer the minute recording magnetic domains, and the minute magnetic domains are hardly expanded. Therefore, it is desirable that the film thickness of the expanding reproducing layer 3 is 15 to 30 nm.

### THIRD EMBODIMENT

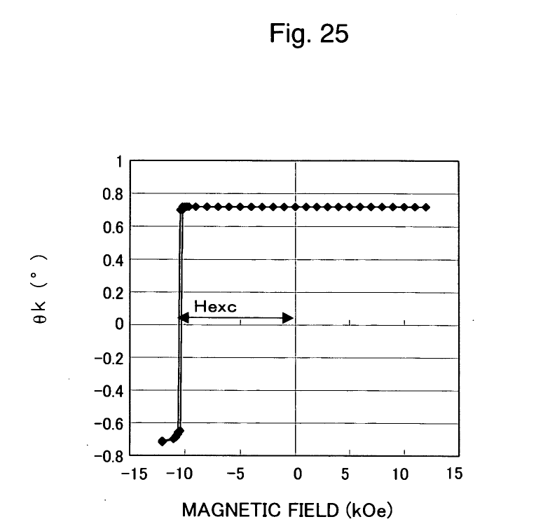

In this embodiment, an explanation will be made about a method for determining the magnitude of the exchange coupling magnetic field (exchange coupling force) acting between the expanding reproducing layer and the recording layer of the magneto-optical disk produced in the first embodiment. The exchange coupling force can be determined by measuring the dependency of the magneto-optical Kerr effect on the magnetic field from the side of the expanding reproducing layer. FIG. 25 shows a hysteresis curve of the magneto-optical disk of the first embodiment at room temperature. The hysteresis curve was determined by allowing a measuring light beam to come into the magneto-optical disk from the side of the expanding reproducing layer and measuring the dependency of the polar magneto-optical Kerr rotation angle on the magnetic field. The exchange coupling magnetic field is exerted on the expanding reproducing layer from the information-recording layer having the large coercivity. The hysteresis curve is shifted to the left (toward the side of the minus magnetic field) in an amount corresponding thereto. The shift amount corresponds to the exchange coupling magnetic field.

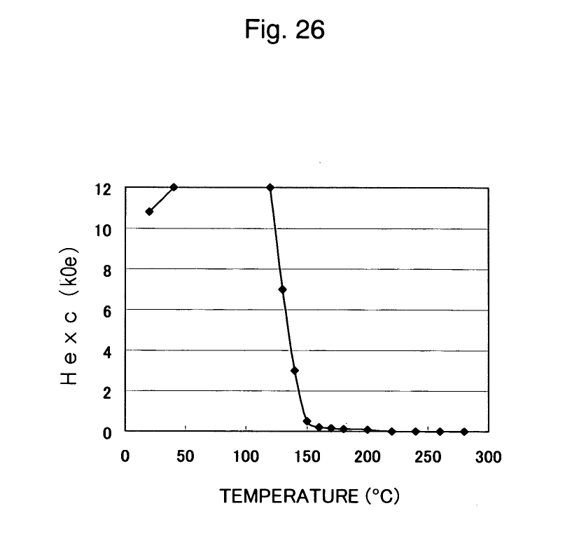

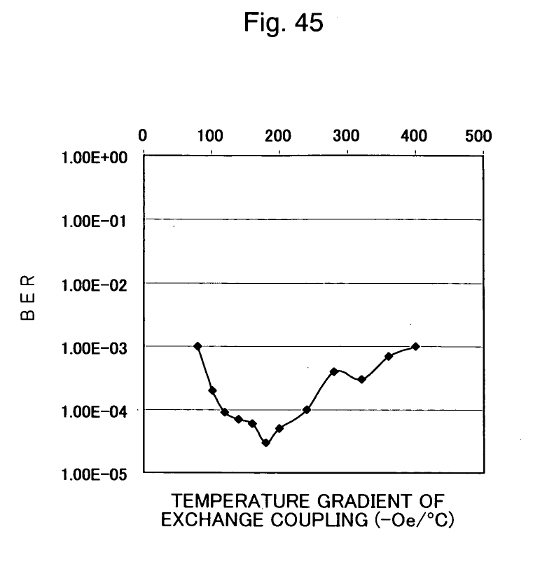

FIG. 26 shows the temperature dependency of the exchange coupling magnetic field (Hexc). The temperature gradient of the exchange coupling magnetic field (exchange coupling force) was measured at a temperature at which the magnitude of the exchange coupling magnetic field, which was required to maintain the magnetic domain transferred to the expanding reproducing layer, was, for example, about 3 kOe. As a result, the temperature gradient was −350 to −185 Oe/° C. It has been revealed that the exchange coupling magnetic field is increased as the thickness of the expanding reproducing layer is thinned, while the exchange coupling magnetic field is increased as the saturation magnetization of the expanding reproducing layer is decreased. Accordingly, a variety of magneto-optical disks were manufactured, in which, for example, the film thickness of the expanding reproducing layer and the saturation magnetization were changed. The temperature dependency of the exchange coupling magnetic field was measured for the manufactured magneto-optical disks to determine the temperature gradient at the temperature at which the exchange coupling magnetic field was about 3 kOe. The saturation magnetization was adjusted by changing the composition of Gd in the expanding reproducing layer. The bit error rate (BER) of each of the magneto-optical disks at the shortest mark length 0.12 μm was measured to investigate the relationship between the temperature gradient and the bit error rate. NRZI was used as the recording pattern. The shortest mark length was about ⅛ of the light spot diameter, which by far exceeds the resolution of the light. FIG. 45 shows the change of the bit error rate with respect to the temperature gradient indicated by the absolute value. In general, the satisfactory bit error rate is not more than 1×10⁻⁴ or 5×10⁻⁴ in a practical viewpoint. Judging from the value of 5×10⁻⁴, it has been revealed that the satisfactory bit error rate is obtained when the temperature gradient is a steep gradient of not less than −100 Oe/° C.

### FOURTH EMBODIMENT

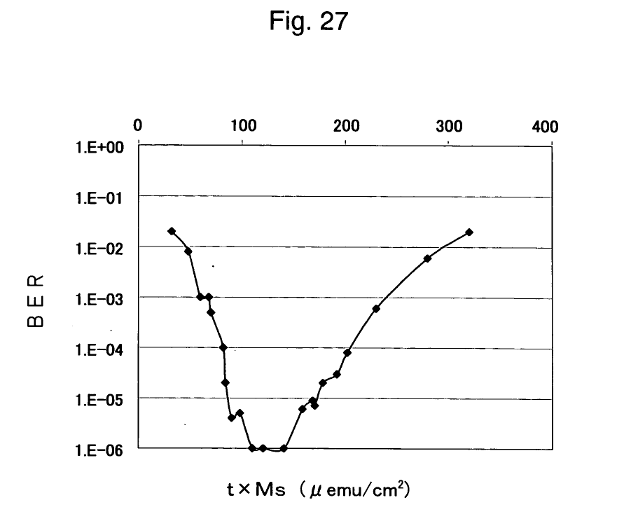

Magneto-optical disks were prepared, which were provided with expanding reproducing layers having various changed values of saturation magnetization (saturation magnetization at room temperature) by changing the film thickness of the expanding reproducing layer of the magneto-optical disk produced in the first embodiment within a range of 10 nm to 40 nm and changing the composition of the expanding reproducing layer. The bit error rate (BER) was measured in the same manner as in the first embodiment for the magneto-optical disks. The shortest mark length was 0.13 μm. FIG. 27 shows the relationship between the bit error rate and the product of the film thickness and the saturation magnetization. The product of the film thickness t of the expanding reproducing layer and the saturation magnetization Ms corresponds to the magnetic energy to cause the expansion of the magnetic domain. When the attention is directed to the range which satisfies 5×10⁻⁴ of the bit error rate, it is appreciated from FIG. 27 that the relatively satisfactory bit error rate is obtained when the product of the film thickness and the saturation magnetization is 80 μemu/cm² to 220 μemu/cm².

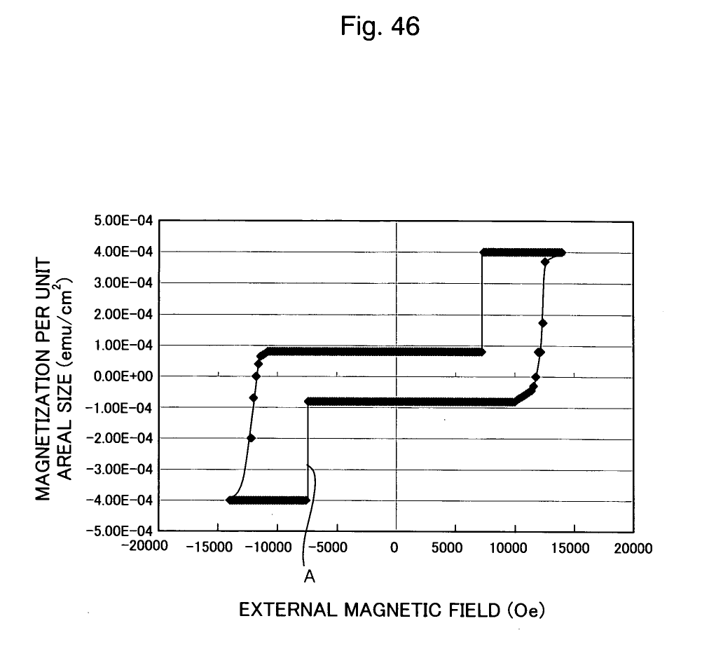

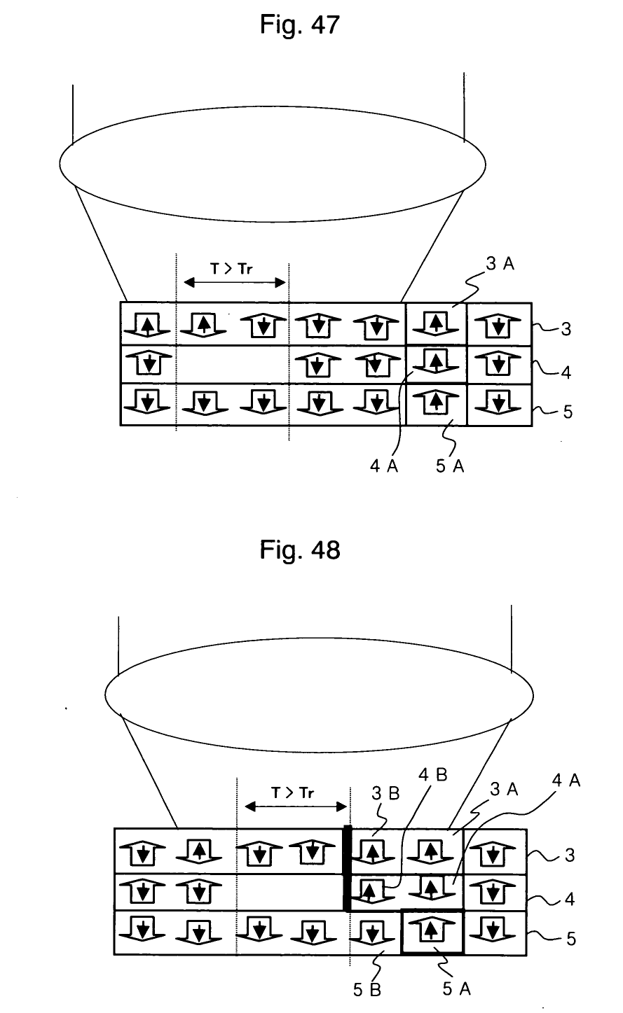

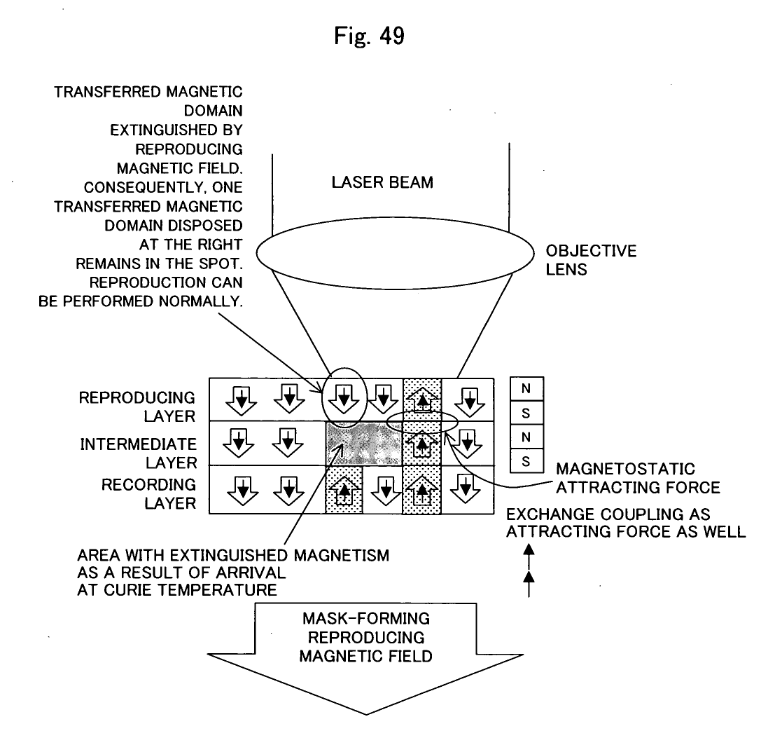

It is also possible to measure (Ms×t) of the expanding reproducing layer from the produced magneto-optical disk. FIG. 46 shows a result of the measurement of the magnetization per unit areal size (cm²) in the vicinity of 120° C. of the disk of the present invention. The magnetic layer for the expansion reproduction can be subjected to the reversal with a relatively small magnetic field, because the coercivity is small. However, the information-recording layer has a large coercivity, and the magnetization reversal is not caused with ease. Therefore, the falling portion of the hysteresis curve, which appears on the side of the negative low magnetic field in FIG. 46, i.e., the change of the magnetization caused at an external magnetic field of about 7 kOe (A in FIG. 46) is considered to correspond to the magnetization reversal of the reproducing layer. It is appreciated that the information-recording layer begins to be reversed in the vicinity of an external magnetic field of 12 koe when the applied magnetic field is further increased. As described above, the magnetization per unit areal size of the expanding reproducing layer can be measured from the falling portion of the hysteresis curve disposed on the low magnetic field side of the magnetization curve. However, the magnetization, which is readable from the hysteresis curve, also includes the magnetization of the intermediate layer, because the intermediate layer is also included in the magneto-optical disk.

### FIFTH EMBODIMENT

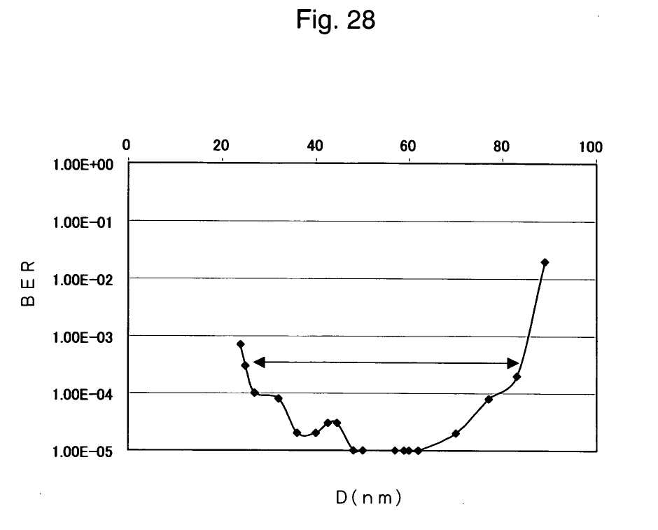

Magneto-optical disks were manufactured in the same manner as in the first embodiment except that the groove depth of the substrate was changed into a variety of depths. The bit error rate was measured in the same manner as in the first embodiment for the respective manufactured magneto-optical disks. FIG. 28 shows the dependency of the bit error rate (BER) on the change of the groove depth D. According to FIG. 28, it is appreciated that the bit error rate of not more than 5×10⁻⁴ is obtained when the groove depth is 27 nm to 82 nm. In general, the groove depth is determined as a function of the wavelength of the light beam on the basis of the reflectance of the light beam. Therefore, the optimum groove depth is λ/16n to λ/5n provided that λ represents the wavelength of the light beam and n represents the refractive index of the protective layer or the substrate on the light-incoming side.

### SIXTH EMBODIMENT

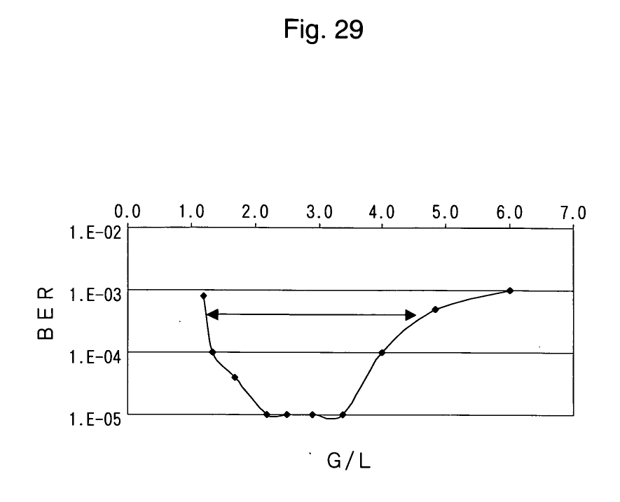

Magneto-optical disks were manufactured in the same manner as in the first embodiment except that substrates, in which the ratio G/L of the groove half value width G with respect to the land half value width L was changed to have a variety of values, were used. The bit error rate was measured on condition that the shortest mark length was 0.13 μm (NRZI) in the same manner as in the first embodiment for the magneto-optical disks described above. FIG. 29 shows the change of the bit error rate with respect to G/L. It is appreciated that the bit error rate of not more than 5×10⁻⁴ is obtained when G/L is within a range of 1.2 to 4.5.

### SEVENTH EMBODIMENT

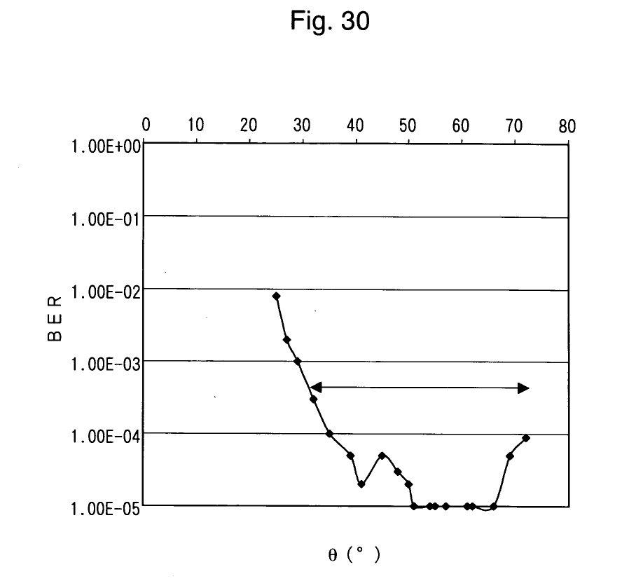

Magneto-optical disks were manufactured in the same manner as in the first embodiment except that substrates, in which the angle of inclination θ of the land side wall was changed to have a variety of values, were used. The bit error rate was measured in the same manner as in the first embodiment for the magneto-optical disks described above. However, the shortest mark length in the recorded NRZI random pattern was 0.13 μm. An obtained result of the measurement is shown in FIG. 30. According to FIG. 30, it is appreciated that the bit error rate of not more than 5×10⁻⁴ is obtained when the angle of inclination θ of the land side wall is within a range of 35° to 77°.

### EIGHTH EMBODIMENT

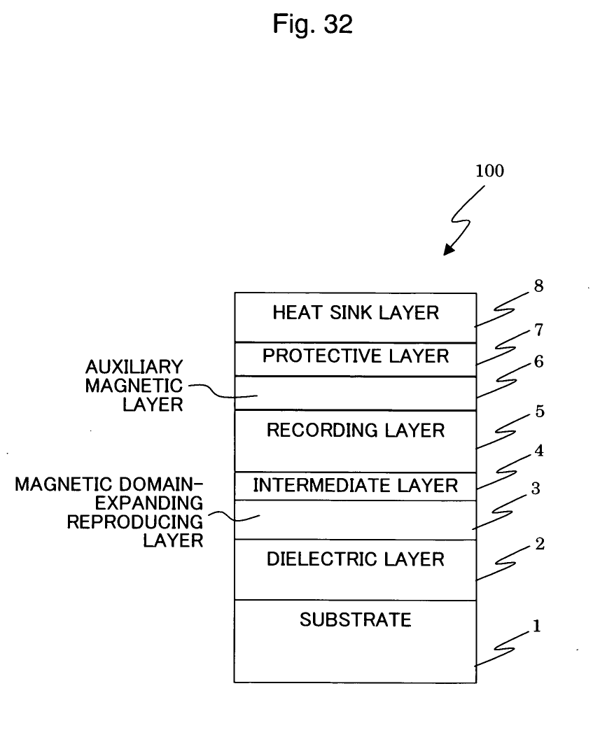

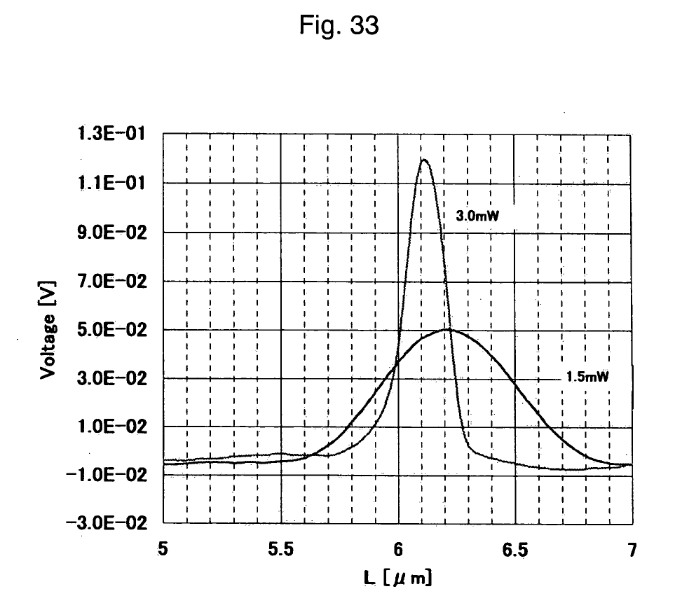

FIG. 32 shows a schematic arrangement of a magneto-optical recording medium according to the present invention. The magneto-optical recording medium 100 comprises, on a substrate 1, a dielectric layer 2, an expanding reproducing layer 3, an intermediate layer 4, a recording layer 5, an auxiliary magnetic layer 6, a protective layer 7, and a heat sink layer 8. The magneto-optical recording medium 100 as described above was formed as follows by using a high frequency sputtering apparatus.

A polycarbonate substrate having a thickness of 0.6 mm, which had a land width of 0.6 μm, a groove width of 0.6 μm, and a groove depth of 60 nm, was used for the substrate 1. The substrate 1 was installed to a film formation chamber of the sputtering apparatus, and the film formation chamber was evacuated until arrival at an attained degree of vacuum of 8×10⁻⁵ Pa. After that, the substrate was vacuum-baked for 5 hours at 80° C. A film of SiN was formed to have a film thickness of 60 nm as the dielectric layer 2 on the substrate 1.

Subsequently, a rare earth transition metal alloy GdFe was formed as a film having a film thickness of 20 nm as the expanding reproducing layer 3 on the dielectric layer 2. GdFe had a Curie temperature of about 240° C. and a compensation temperature of not less than the Curie temperature. The saturation magnetization at 160° C. was about 55 emu/cm³. Subsequently, a rare earth transition metal alloy TbGdFe, which had a compensation temperature of not more than room temperature, was formed as a film having a film thickness of 10 nm as the intermediate layer 4 on the expanding reproducing layer 3. The Curie temperature was about 150° C. The ratio between Tb and Gd was 14%. Subsequently, a rare earth transition metal alloy TbFeCo, which had a Curie temperature of 280° C. and a compensation temperature in the vicinity of room temperature, was formed as a film having a film thickness of 60 nm as the recording layer 5 on the intermediate layer 4. All of the three magnetic layers, i.e., the expanding reproducing layer 3, the intermediate layer 4, and the recording layer 5 were perpendicularly magnetizable films at temperatures from room temperature to the Curie temperatures.

Subsequently, in order to make it possible to perform the correct recording with a small recording magnetic field, a rare earth transition metal alloy GdFeCo, which had a compensation temperature of not more than room temperature and a Curie temperature of 290° C., was formed as a film having a film thickness of 10 nm as the auxiliary magnetic layer 6 on the recording layer 5. Subsequently, a film of SiN was formed to have a film thickness of 20 nm as the protective layer 7 on the auxiliary magnetic layer 6. A film of Al was formed to have a film thickness of 30 nm as the heat sink layer 8 on the protective layer 7. Thus, the magneto-optical recording medium 100 having the stacked structure shown in FIG. 32 was manufactured.

Subsequently, the magneto-optical recording medium was installed to a testing instrument to perform a playback test. A laser beam having a wavelength of 650 nm and an objective lens having a numerical aperture NA of 0.60 were used in the playback test. The linear velocity was 5 m/sec. At first, in order to confirm the phenomenon of the magnetic domain expansion in the magnetic recording and reproducing layer, isolated magnetic domains each having a length of 0.20 μm were recorded on the magneto-optical recording medium by using the light pulse magnetic field modulation recording system on condition that the recording power of the laser beam was 10 mW and the recording magnetic field was ±200 Oe. The pulse duty of the light beam was 30%. The recording cycle was 2.0 μm. This value corresponds to a length which is about twice the light spot diameter λ/NA (about 1 μm). On the other hand, the length of the recorded isolated magnetic domain corresponds to a length which is about ⅕ of the light spot diameter λ/NA.

The magneto-optical recording medium, in which the isolated magnetic domains had been formed as described above, was subjected to the reproduction by using two types of reproducing powers of 1.5 mW and 3.0 mW. FIG. 33 shows reproduced signals obtained from the isolated magnetic domains when the reproduction was performed with the reproducing power of 1.5 mW and when the reproduction was performed with the reproducing power of 3.0 mW. According to a preliminary test, it has been confirmed that the reproducing power of 3.0 mW is the optimum reproducing power at which the signal-to-noise ratio (C/N) is maximized. When the reproducing power was 1.5 mW, then the half value width of the reproduced signal waveform was 0.66 μm, the width of the lower slope was 1.34 μm, and the signal amplitude was about 54 mV. On the other hand, when the reproducing power was 3.0 mW, then the half value width of the reproduced signal waveform was 0.20 μm, the width of the lower slope was 0.64 μm, and the signal amplitude was about 126 mV. According to the result described above, the following fact is appreciated. That is, the width of the reproduced signal waveform is narrowed, the resolution is improved, and the signal amplitude is increased as well. When the reproducing power is regulated to be 3.0 mW, the magnetic domain expansion reproduction is successfully performed.

In general, the higher the reproducing power is, the more increased the signal amplitude is. However, when the reproducing power is increased, then the temperature of the reproducing layer is raised, and the magneto-optical effect is consequently decreased. Actually, the magneto-optical effect is considerably decreased at high temperatures. Accordingly, for the purpose of reference, the expansion ratio of the magnetic domain in the expanding reproducing layer was calculated. The expansion ratio was approximately calculated by normalizing the signal amplitude with the reproducing power. When the reproducing power was 1.5 mW, the normalized signal amplitude was 36 mV/mW. When the reproducing power was 3.0 mW, the normalized signal amplitude was 42 mV/mW. It is appreciated that the magnetic domain is expanded by at lease not less than 16%.

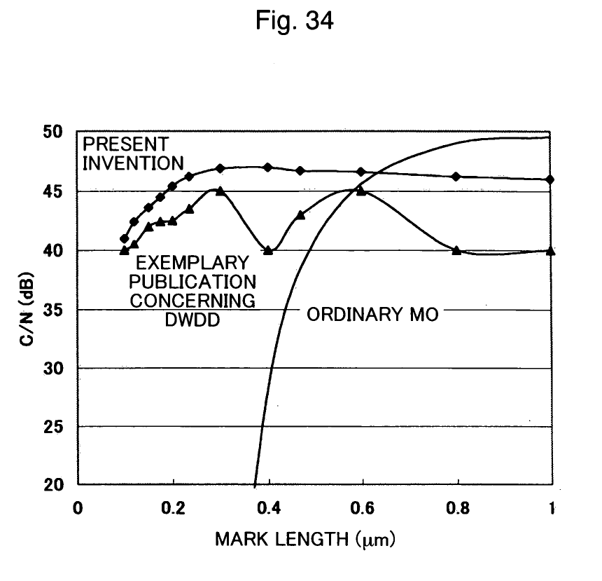

Subsequently, the mark length dependency of the signal-to-noise ratio (C/N) of the magneto-optical recording medium of the present invention was investigated. An obtained result is shown in FIG. 34. For the purpose of comparison, FIG. 34 also shows the mark length dependency of the signal-to-noise ratio (C/N) of each of an ordinary magneto-optical recording medium and a magneto-optical recording medium described in an exemplary report on DWDD (T. Shiratori, J. Magn. Soc. Jpn., Vol. 22, Supplement No. 2 (1998), p. 50, FIG. 10). According to the graph shown in FIG. 34, for example, C/N at 0.20 μm exhibits an extremely large value, i.e., 45.4 dB in the present invention. However, in the case of DWDD, the value is low, i.e., about 41 dB. Further, a reproduced signal exceeding 45 dB is obtained in the present invention even when the mark length is 1.0 μm, although the measurement is unsuccessful in relation to long marks due to the ghost signal in DWDD.

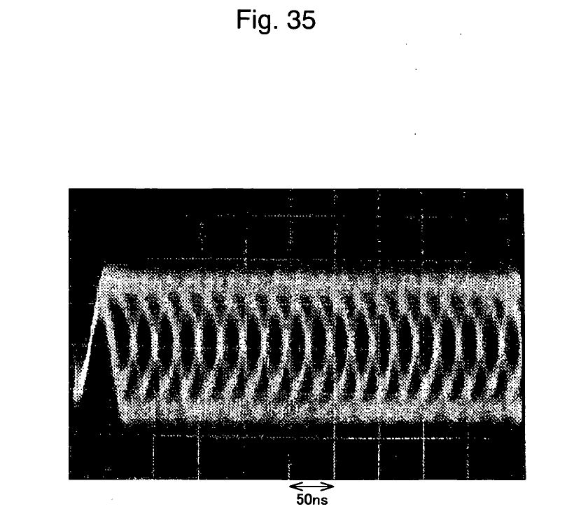

FIG. 35 shows a reproduced waveform of an NRZI random pattern having a shortest mark length of 0.12 μm according to the present invention. In the case of the magneto-optical recording medium of the present invention, it is unnecessary to restrict the length of the recording mark, because no ghost signal appears. A satisfactory eye pattern was obtained irrelevant to the mark length. When the bit error rate was measured by simply slicing the signal shown in FIG. 35 at the middle portion, a value of 4.7×10⁻⁵ was obtained. The value greatly exceeds the practical standard of 1×10⁻⁴.

### NINTH EMBODIMENT

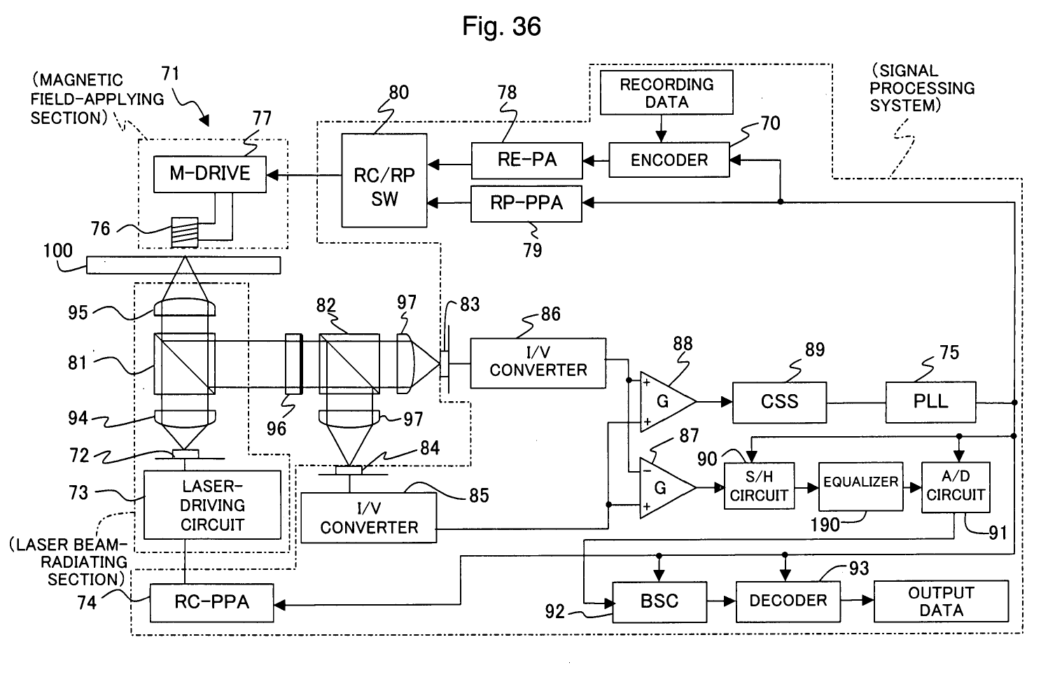

FIG. 36 shows an arrangement of a recording and reproducing apparatus which is most appropriate for the recording and the reproduction on the magneto-optical recording medium of the present invention. The recording and reproducing apparatus 71 shown in FIG. 36 principally comprises a laser beam-radiating section which radiates a light beam pulsed at a constant cycle in synchronization with code data onto the magneto-optical disk 100, a magnetic field-applying section which applies a controlled magnetic field to the magneto-optical disk 100 during the recording and the reproduction, and a signal processing system which detects and processes a signal obtained from the magneto-optical disk 100. In the laser beam-radiating section, a laser 72 is connected to a laser-driving circuit 73 and a recording pulse width/phase-adjusting circuit 74 (RC-PPA). The laser-driving circuit 73 receives a signal supplied from the recording pulse width/phase-adjusting circuit 74 to control the laser pulse width and the phase of the laser 72. The recording pulse width/phase-adjusting circuit 74 receives a clock signal supplied from a PLL circuit 75 as described later on to generate a first synchronization signal in order to adjust the phase and the pulse width of the recording light beam.

In the magnetic field-applying section, a magnetic coil 76 for applying the magnetic field is connected to a magnetic coil-driving circuit (M-DRIVE) 77. During the recording, the magnetic coil-driving circuit 77 receives input data supplied via a phase-adjusting circuit (RE-PA) 78 from an encoder 70 to which data is inputted, and the magnetic coil-driving circuit 77 controls the magnetic coil 76. On the other hand, during the reproduction, the magnetic coil-driving circuit 77 receives a clock signal supplied from a PLL circuit 75 as described later on to generate a second synchronization signal for adjusting the phase and the pulse width by the aid of a reproducing pulse width/phase-adjusting circuit (RP-PPA) 79, and the magnetic coil 76 is controlled on the basis of the second synchronization signal. In order to switch the signal to be inputted into the magnetic coil-driving circuit 77 between the recording and the reproduction, a recording/reproduction selector switch (RC/RPSW) 80 is connected to the magnetic coil-driving circuit 77.

In the signal processing system, a first polarizing prism 81 is arranged between the laser 72 and the magneto-optical disk 100. A second polarizing prism 82 and detectors 83, 84 are arranged on the side of the first polarizing prism 81. The detectors 83, 84 are connected to both of a subtractor 87 and an adder 88 via I/V converters 85, 86 respectively. The adder 88 is connected to the PLL circuit 75 via a clock-sampling circuit (SCC) 89. The subtractor 87 is connected to a decoder 93 via a sample hold circuit (S/H) 90 for holding the signal in synchronization with the clock, an A/D converter circuit 91 for performing analog-digital conversion in synchronization with the clock as well, and a binary signal processing circuit (BSC) 92.

As shown in FIG. 36, the signal processing system is provided with a signal processing unit 190 which is disposed between the S/H circuit 90 and the A/D converter circuit 91 and which cuts the low pass signal. The signal processing unit 190 is operated such that the waveform is equalized with an equalizing circuit to compress the low pass noise and a modulated signal is formed with an A/D circuit after the sample hold.

In the apparatus constructed as described above, the light beam, which is radiated from the laser 72, is converted into a parallel light beam by using a collimator lens 94. The light beam is allowed to pass through the polarizing prism 81, and the light beam is collected by an objective lens 95 onto the magneto-optical disk 100. The reflected light beam from the disk is bent by the polarizing prism 81 in the direction toward the polarizing prism 82. The light beam is transmitted through a ½ wavelength plate 96, and then the light beam is divided by the polarizing prism 82 into those directed in two directions. The divided light beams are collected by detecting lenses 97 respectively, and the light beams are guided to the detectors 83, 84. In this arrangement, pits for generating the tracking error signal and the clock signal may be previously formed on the magneto-optical disk 100. A signal, which indicates the reflected light beam coming from the clock signal-generating pits, is detected by the detectors 83, 84, and then the signal is sampled with the clock-sampling circuit 89. Subsequently, the data channel clock is generated by the PLL circuit 75 which is connected to the clock-sampling circuit 89.

During the recording of data, the laser 72 is modulated with a constant frequency by the laser-driving circuit 73 so as to make the synchronization with the data channel clock. A continuous pulse light beam having a narrow width is radiated so that a data recording area of the rotating magneto-optical disk 100 is locally heated at equal intervals. The data channel clock controls the encoder 70 of the magnetic field-applying section to generate a data signal at a reference clock cycle. The data signal is fed to the magnetic coil-driving unit 77 via the phase-adjusting circuit 78. The magnetic coil-driving unit 77 controls the magnetic coil 76 so that the magnetic field, which has a polarity corresponding to the data signal, is applied to the heated portion of the data recording area of the magneto-optical disk 100.

As for the recording system, the light pulse magnetic field modulation system is used. This system resides in the following technique. That is, the laser beam is radiated in a pulse form at a timing at which the applied recording magnetic field arrives at a sufficient magnitude. Therefore, it is possible to omit the recording in an area in which the external magnetic field is switched. As a result, minute magnetic domains can be recorded at a low noise level.

When information is reproduced, it is unnecessary to apply any reproducing magnetic field to the magneto-optical recording medium. The magneto-optical recording medium is irradiated with the reproducing light beam, and the minute magnetic domains of the recording layer are transferred to the reproducing layer, and they are expanded on the basis of the principle of reproduction on the magneto-optical recording medium of each of the first to third types described above. The returning light beam returned from the magneto-optical recording medium is detected by the photodetector to reproduce the information. A continuous light beam or a pulse light beam can be used for the reproducing light beam. A reproducing light beam, in which the reproducing power is modulated, can be used as well.

When the reproduction is performed on the magneto-optical recording medium, a modulated reproducing magnetic field may be also applied in order to easily expand the magnetic domain of the reproducing layer on the basis of the principle described above.

### TENTH EMBODIMENT

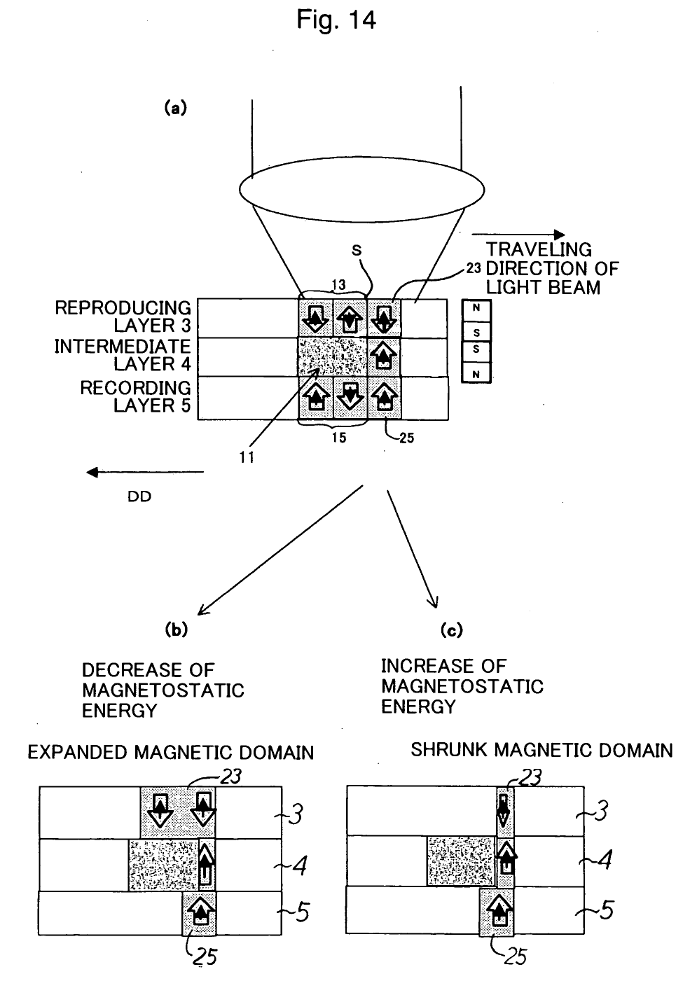

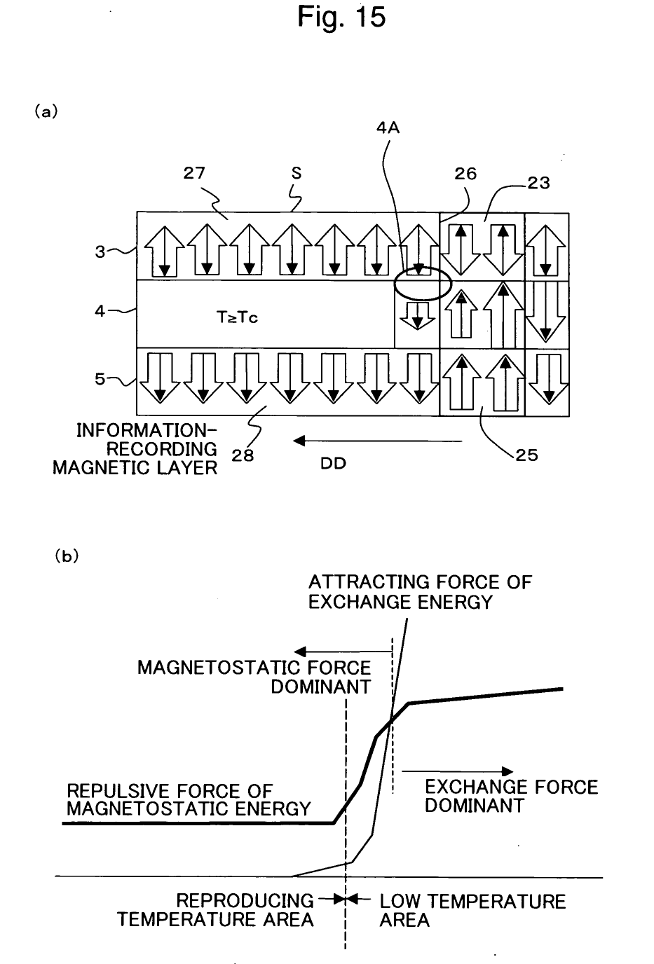

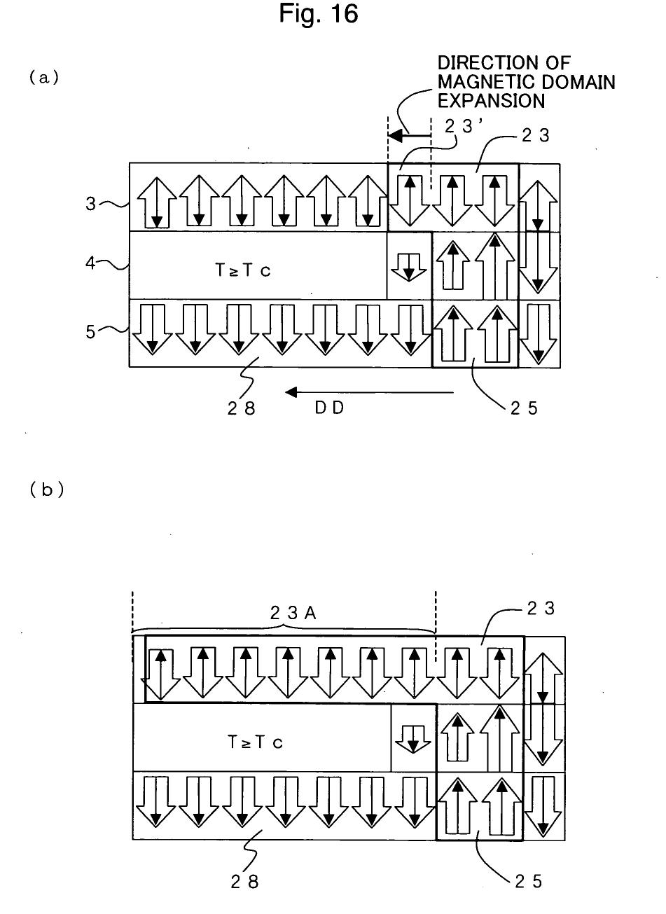

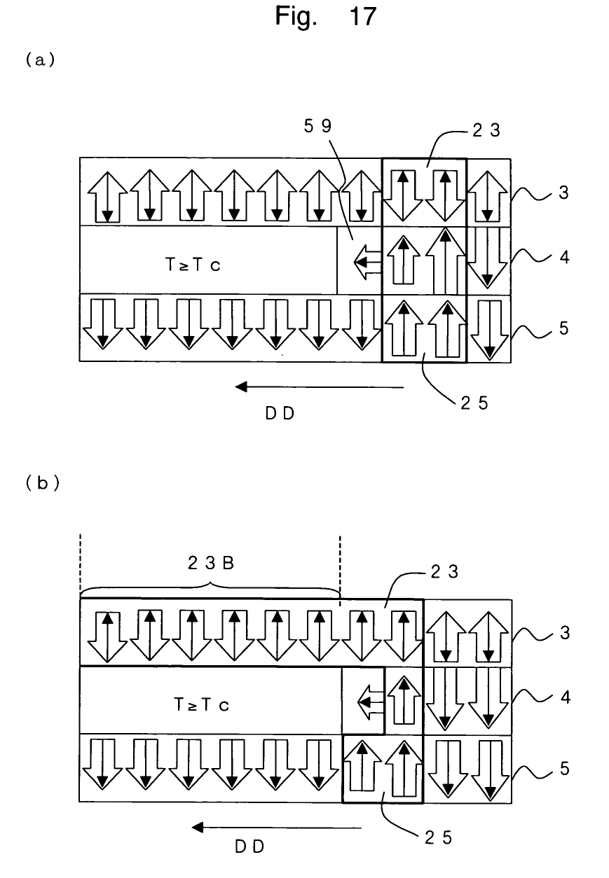

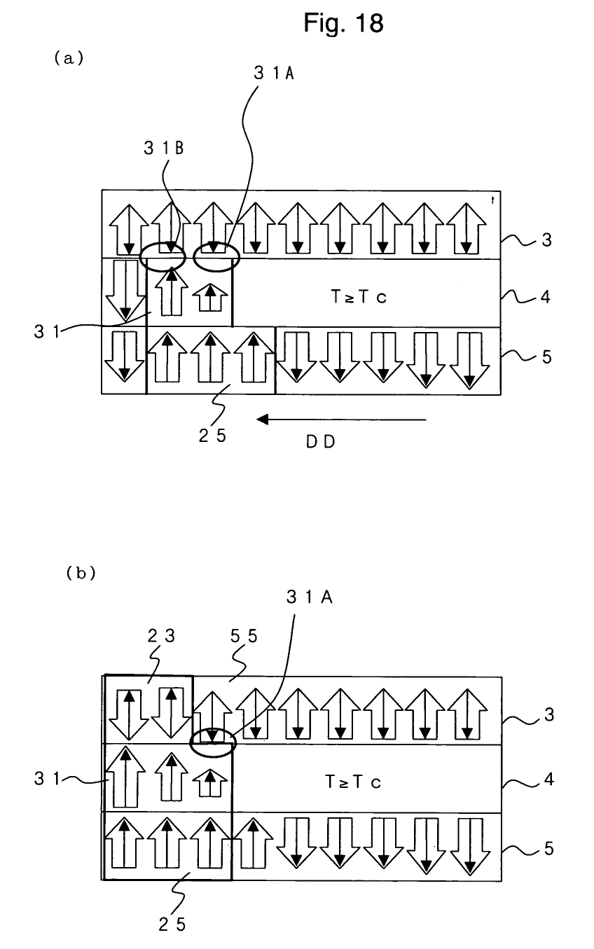

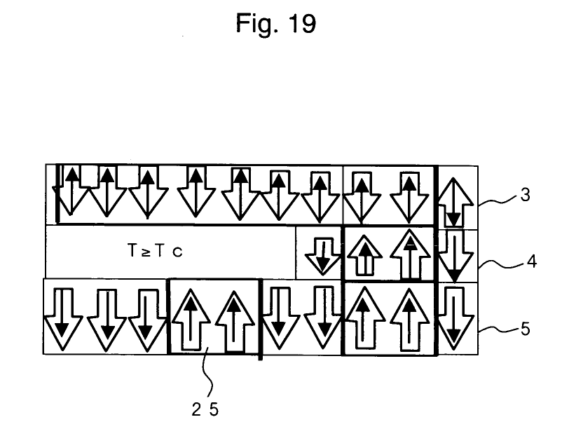

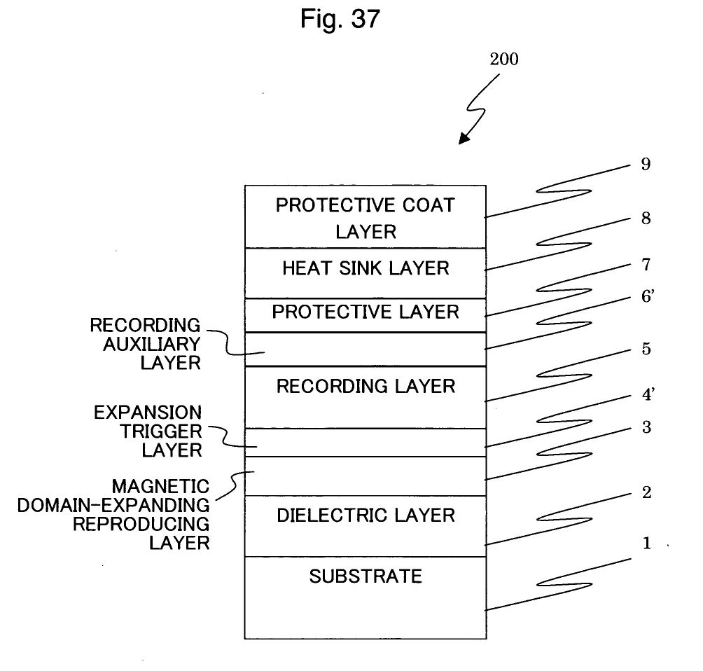

An explanation will be made with reference to FIGS. 37 and 14 about another magneto-optical recording medium according to the present invention. As shown in FIG. 37, the magneto-optical disk 200 comprises, on a substrate 1, a dielectric layer 2, an expanding reproducing layer 3, an expansion trigger layer 4′, a recording layer 5, a recording auxiliary layer 6′, a protective layer 7, and a heat sink layer 8. The respective layers of the magneto-optical disk 200 were formed as films by using a high frequency sputtering apparatus (not shown).

The substrate 1 is formed of transparent polycarbonate having a diameter of 120 mm and a thickness of 0.6 mm. As shown in FIG. 21, lands 1L and grooves 1G defined between the lands 1L are formed on the surface of the substrate 1 with the injection molding. As shown in FIG. 21, the angle of inclination of the land side wall LW is designated as θ, and the width of the land 1L, which is obtained at a height position of a half (D/2) of the height of the land 1L, i.e., the depth D of the groove 1G, is designated as the land half value width L. The width of the groove, which is obtained at a height position of a half of the depth D of the groove 1G, is designated as the groove half value width G. The groove half value width is the distance between an intermediate position of a land side wall LW of a certain land in the height direction and an intermediate position of a land side wall LW of an adjoining land in the height direction. In this arrangement, the track pitch TP is represented by TP=G+L.

In this embodiment, substrates having a variety of geometries as shown in Table 1 were prepared.

TABLE 1

| TP (μm) | G (μm) | L (μm) | G/L* | D (nm) | θ (°) |
|---|---|---|---|---|---|
| 0.70 | 0.38 | 0.32 | 1.2 | 60 | 65 |
| 0.70 | 0.40 | 0.30 | 1.3 | 60 | 65 |
| 0.70 | 0.44 | 0.26 | 1.7 | 60 | 65 |
| 0.70 | 0.48 | 0.22 | 2.2 | 60 | 65 |
| 0.70 | 0.50 | 0.20 | 2.5 | 60 | 65 |
| 0.70 | 0.52 | 0.18 | 2.9 | 60 | 65 |
| 0.70 | 0.54 | 0.16 | 3.4 | 60 | 65 |
| 0.70 | 0.56 | 0.14 | 4.0 | 60 | 65 |
| 0.70 | 0.58 | 0.12 | 4.8 | 60 | 65 |
| 0.70 | 0.60 | 0.10 | 6.0 | 60 | 65 |
| 0.52 | 0.38 | 0.32 | 1.2 | 60 | 65 |

*G/L was rounded to the nearest tenth from the hundredths place.

Each of the surfaces of the substrates was irradiated with ultraviolet light having a peak wavelength λ of 185+254 nm by using an ultraviolet lamp. The lamp was installed at a position having a height of 70 mm over the surface of the substrate 1, and the substrate 1 was rotated at a velocity of 2 rpm to effect the smoothing so that the surface roughness was 0.3 nm thereby.

Subsequently, the dielectric layer 2 was formed to have a thickness of 60 nm on the surface of the substrate 1 on which the lands and the grooves were formed, by using Si as a target material in an atmosphere of Ar+N₂. The dielectric layer 2 is a layer which is provided in order that that the reproducing light beam is subjected to the multiple interference in the layer and the Kerr rotation angle to be detected is substantially increased.

Subsequently, simple substance targets of Gd and Fe were co-sputtered on the surface of the dielectric layer 2, and the expanding reproducing layer 3 was formed to have a film thickness of 20 nm. Accordingly, the formed GdFe expanding reproducing layer 3 was a perpendicularly magnetizable film, the Curie temperature was about 240° C., and the compensation temperature was not-less than the Curie temperature. The expanding reproducing layer 3 is a layer in which the magnetic domains transferred from the recording auxiliary layer 6′ are magnified.

Subsequently, simple substance targets of Tb, Gd, and Fe were co-sputtered on the expanding reproducing layer 3, and thus the expansion trigger layer 4′ was formed to have a film thickness of 10 nm. On this condition, the TbGdFe expansion trigger layer 4′ was a perpendicularly magnetizable film, the Curie temperature was 140° C., and the compensation temperature was not more than room temperature. The expansion trigger layer 4′ is magnetically subjected to the exchange coupling to the expanding reproducing layer 3 and the recording layer 5 respectively.

Subsequently, simple substance targets of Tb, Fe, and Co were co-sputtered on the expansion trigger layer 4′, and thus the TbFeCo recording layer 5 was formed to have a film thickness of 75 nm. The recording layer 5 had a Curie temperature of 250° C. and a compensation temperature of about 25° C. The recording layer 5 is a layer in which information is recorded as magnetization.

Subsequently, simple substance targets of Gd, Fe, and Co were co-sputtered on the recording layer 5, and thus the GdFeCo recording auxiliary layer 6′ was formed to have a film thickness of 10 nm. The recording auxiliary layer 6′ had a Curie temperature of 270° C. and a compensation temperature of not more than room temperature. The recording auxiliary layer 6′ is a layer which makes the exchange coupling with respect to the recording layer 5 so that the recording is successfully performed in the recording layer 5 with a smaller modulated magnetic field.

Subsequently, the protective layer 7 was formed to have a film thickness of 20 nm on the recording auxiliary layer 6′ by performing the sputtering by using Si as a target material in an atmosphere of Ar+N₂. The protective layer 7 is a layer which protects the respective layers 2 to 6′ stacked on the substrate 1.

The heat sink layer 8 was formed to have a film thickness of 30 nm on the protective layer 7 by using an alloy of AlTi as a target. The heat sink layer 8 is a layer which releases the heat generated in the magneto-optical disk to the outside during the recording. An acrylic ultraviolet-curable resin was applied onto the heat sink layer 8, followed by being cured by being irradiated with ultraviolet light to form the protective coat layer 9 with a film thickness of 10 μm.

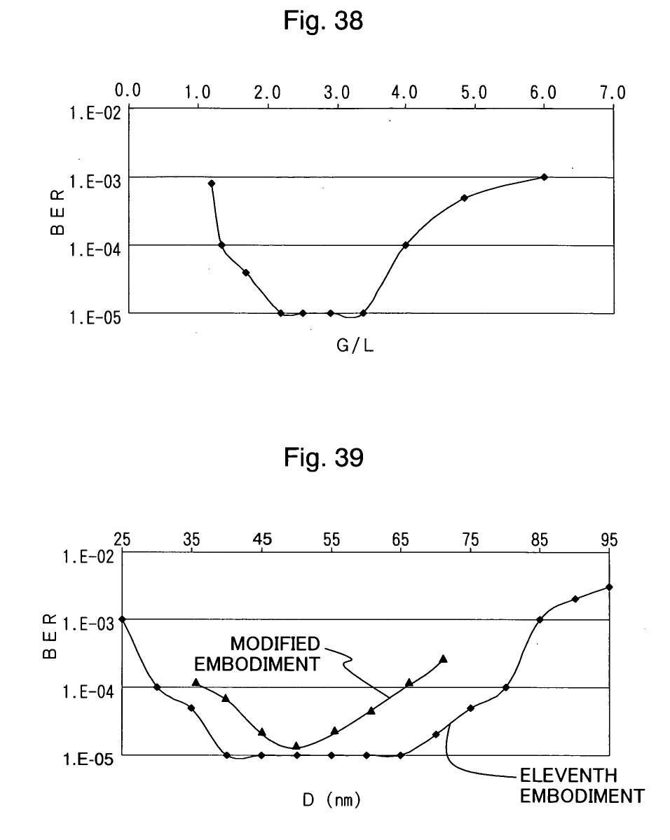

Subsequently, an information playback test was performed for the magneto-optical disk 200 manufactured in this embodiment by using an unillustrated magneto-optical recording and reproducing apparatus. The magneto-optical recording and reproducing apparatus is provided with an optical head including a laser beam having a wavelength of 640 nm and an objective lens having an numerical aperture (NA) of 0.6. The light pulse magnetic field modulation system was used as the recording system, in which the laser beam was radiated in a pulse form and the external magnetic field was applied while modulating the external magnetic field depending on the recording information. The linear velocity during the recording was 3.5 m/sec, and the recording magnetic field was modulated to ±200 Oe. The duty of the pulse light beam during the recording was 30%, and the recording power of the laser beam was optimized. A random pattern having a shortest mark length of 0.12 μm was recorded on the groove portion. After that, the bit error rate (BER) was measured by using the reproducing light beam with the optimized reproducing power. The bit error rate was measured for the magneto-optical disks having the various G/L ratios shown in Table 1 respectively. FIG. 38 shows a graph illustrating the change of the bit error rate with respect to G/L. The threshold value (upper limit) of the bit error rate was prescribed to be 5×10⁻⁴. According to the graph shown in FIG. 38, it is appreciated that the satisfactory bit error rate is exhibited when G/L satisfies 1.3≦G/L≦4.0.

This embodiment is illustrative of the case in which the magneto-optical disk has the eight layers (except for the protective coat layer 9). However, it has been revealed that the range of G/L as described above is effective for the magneto-optical disk which has such a basic layer structure that the recording layer for retaining information and the expanding reproducing layer for transferring the retained information thereto during the reproduction are provided on the substrate. This embodiment uses the ultraviolet light radiation method as the method for smoothing the substrate surface. However, it is also allowable to use, for example, the substrate-heating method and the plasma etching method.

### ELEVENTH EMBODIMENT

Magneto-optical disks were manufactured in the same manner as in the tenth embodiment except that the groove and the land of the substrate 1 were manufactured to have geometries as shown in Table 2.

TABLE 2

| TP (μm) | G (μm) | L (μm) | G/L* | D (nm) | θ (°) |
|---|---|---|---|---|---|
| 0.70 | 0.50 | 0.20 | 2.5 | 25 | 65 |
| 0.70 | 0.50 | 0.20 | 2.5 | 30 | 65 |
| 0.70 | 0.50 | 0.20 | 2.5 | 35 | 65 |
| 0.70 | 0.50 | 0.20 | 2.5 | 40 | 65 |
| 0.70 | 0.50 | 0.20 | 2.5 | 45 | 65 |
| 0.70 | 0.50 | 0.20 | 2.5 | 50 | 65 |
| 0.70 | 0.50 | 0.20 | 2.5 | 55 | 65 |
| 0.70 | 0.50 | 0.20 | 2.5 | 60 | 65 |
| 0.70 | 0.50 | 0.20 | 2.5 | 65 | 65 |
| 0.70 | 0.50 | 0.20 | 2.5 | 70 | 65 |
| 0.70 | 0.50 | 0.20 | 2.5 | 75 | 65 |
| 0.70 | 0.50 | 0.20 | 2.5 | 80 | 65 |
| 0.70 | 0.50 | 0.20 | 2.5 | 85 | 65 |
| 0.70 | 0.50 | 0.20 | 2.5 | 90 | 65 |
| 0.70 | 0.50 | 0.20 | 2.5 | 95 | 65 |

*G/L was rounded to the nearest tenth from the hundredths place.

In this embodiment, the plurality of magneto-optical disks were manufactured by changing only the depth D of the groove. A random pattern was recorded and reproduced by using an unillustrated magneto-optical recording and reproducing apparatus in the same manner as in the tenth embodiment. The change of the bit error rate with respect to the groove depth D was investigated for the respective magneto-optical disks. An obtained result is shown in FIG. 39. On condition that the threshold value of the bit error rate is 1×10⁻⁴, it is appreciated from FIG. 39 that the satisfactory bit error rate is achieved when the value of D is 30 nm to 80 nm.

In a modified embodiment, a variety of magneto-optical disks were manufactured in the same manner as in the eleventh embodiment except that TbGdFeCo was formed to have a film thickness of 10 nm as the expansion trigger layer, and the groove depth of the substrate was changed to 70 nm, 65 nm, 60 nm, 55 nm, 50 nm, 45 nm, 40 nm, 35 nm, and 30 nm. The expansion trigger layer was obtained by co-sputtering simple substance targets of Tb, Gd, Fe, and Co, and the film composition was adjusted to obtain a perpendicularly magnetizable film having a compensation temperature of not more than room temperature. The expansion trigger layer 4 serves to cut off the exchange coupling force between the reproducing layer 3 and the recording layer 5 at 140° C. The bit error rate was measured for the magneto-optical disks in the same manner as in the eleventh embodiment to investigate the change of the bit error rate with respect to the groove depth D. An obtained result is shown as the modified embodiment in FIG. 39. The shortest mark length was 0.13 μm. It is appreciated that the satisfactory bit error rate is achieved when the value of D is 35 nm to 65 nm.

It is considered that the error rate is lowered when the groove depth of the substrate is deep to be not less than 70 nm, because the end of the groove is hardly heated and the expansion reproduction of the recording mark is inhibited. On the other hand, when the groove depth of the substrate was not more than 30 nm, then the tracking signal was decreased, and it was impossible to chase the groove. Therefore, it is understood that the groove depth of 3.0 to 70 nm, especially 35 to 65 nm is most suitable for the magneto-optical disk of this embodiment.

This embodiment is illustrative of the use of the reproducing laser beam having the wavelength of 650 nm by way of example. However, in general, the phase difference between the incident light beam coming into the substrate and the reflected light beam reflected from the substrate is definitely determined by the wavelength of the reproducing laser beam, the refractive index of the substrate, and the groove depth of the substrate. Therefore, it is appreciated from this embodiment that the magneto-optical disk desirably has the substrate in which the groove depth is λ/12n to λ/7n.

### TWELFTH EMBODIMENT

Magneto-optical disks were manufactured in the same manner as in the tenth embodiment except that the groove and the land of the substrate 1 were manufactured to have geometries as shown in Table 3.

TABLE 3

| TP (μm) | G (μm) | L (μm) | G/L* | D (nm) | θ (°) |
|---|---|---|---|---|---|
| 0.70 | 0.50 | 0.20 | 2.5 | 60 | 30 |
| 0.70 | 0.50 | 0.20 | 2.5 | 60 | 35 |
| 0.70 | 0.50 | 0.20 | 2.5 | 60 | 40 |
| 0.70 | 0.50 | 0.20 | 2.5 | 60 | 45 |
| 0.70 | 0.50 | 0.20 | 2.5 | 60 | 50 |
| 0.70 | 0.50 | 0.20 | 2.5 | 60 | 55 |
| 0.70 | 0.50 | 0.20 | 2.5 | 60 | 60 |
| 0.70 | 0.50 | 0.20 | 2.5 | 60 | 65 |
| 0.70 | 0.50 | 0.20 | 2.5 | 60 | 70 |
| 0.70 | 0.50 | 0.20 | 2.5 | 60 | 75 |
| 0.70 | 0.50 | 0.20 | 2.5 | 60 | 80 |

*G/L was rounded to the nearest tenth from the hundredths place.

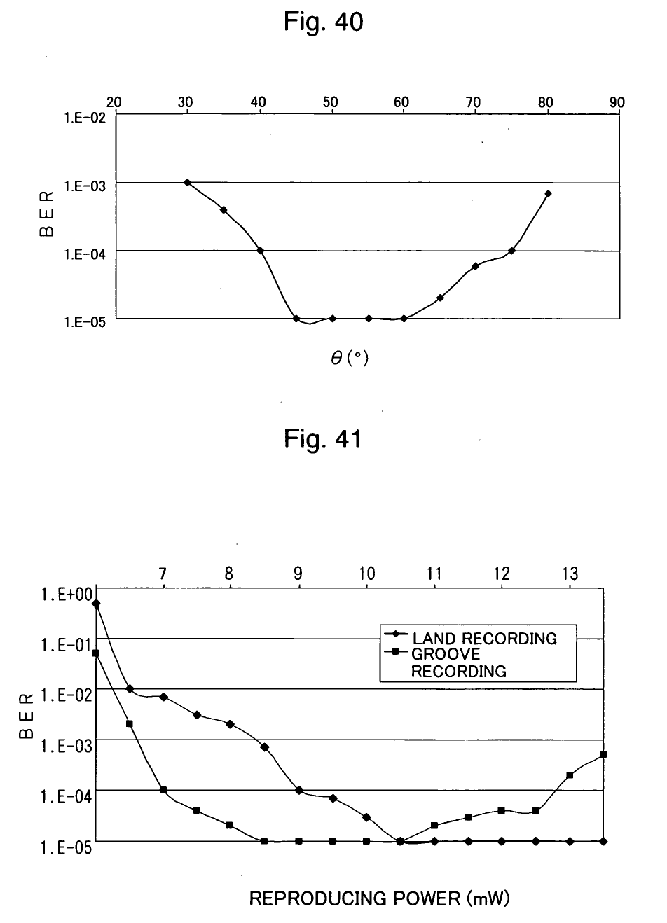

In this embodiment, the plurality of magneto-optical disks were manufactured by using the substrates shown in Table 3 while changing only the angle of inclination θ of the land side wall surface (wall surface for comparting the groove) of the substrate. A random pattern was recorded and reproduced by using an unillustrated magneto-optical recording and reproducing apparatus in the same manner as in the tenth embodiment. The change of the bit error rate with respect to the angle of inclination θ of the land side wall surface was investigated for the respective magneto-optical disks. An obtained result is shown in FIG. 40. According to FIG. 40, the value of θ is preferably 35° to 77° when the threshold value (upper limit) of the bit error rate is 5×10⁻, and the value of θ is preferably 40° to 75° when the threshold value of the bit error rate is 1×10⁻⁴.

### COMPARATIVE EXAMPLE (LAND RECORDING)

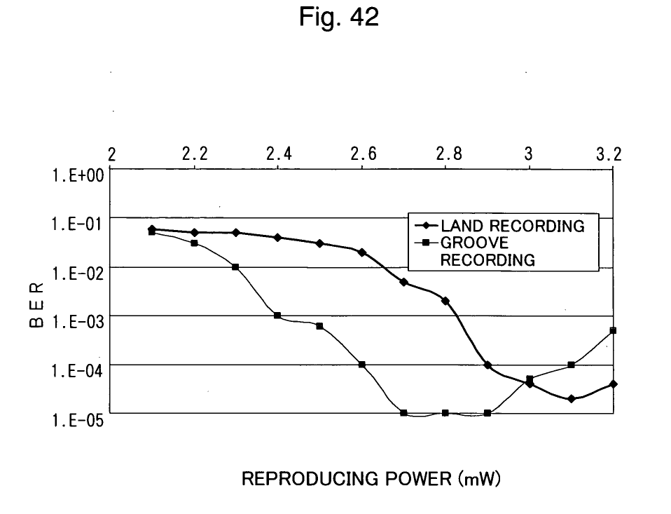

A magneto-optical disk was manufactured in the same manner as in the tenth embodiment except that the groove and the land of the substrate 1 were formed so that the track pitch (TP) was 0.70 μm, the land half value width (L) was 0.50 μm, the groove half value width (G) was 0.20 μm, the groove depth (D) was 60 nm, and the angle of inclination (θ) of the land side wall surface was 65°. Subsequently, a random pattern was recorded and reproduced on the magneto-optical disk by using the magneto-optical recording and reproducing apparatus in the same manner as in the tenth embodiment. However, the recording power of the laser beam was changed to record the random pattern having a shortest mark length of 0.13 μm on the land portion. The respective recording patterns were reproduced to investigate the dependency of the bit error rate on the recording power. FIG. 41 shows a graph illustrating the dependency of the bit error rate on the recording power. Subsequently, the reproduction was performed on condition that the recording power was constant and the recording power was varied to determine the dependency of the bit error rate on the reproducing power. FIG. 42 shows a graph illustrating the dependency of the bit error rate on the reproducing power. In any case, the upper limit of the threshold value was 1×10⁻⁴.

### REFERENCE EXAMPLE (GROOVE RECORDING)

A magneto-optical disk was manufactured in the same manner as in Comparative Example except that the groove and the land of the substrate 1 were formed so that the track pitch (TP) was 0.70 μm, the land half value width (L) was 0.20 μm, the groove half value width (G) was 0.50 μm, the groove depth (D) was 60 nm, and the angle of inclination (θ) of the land side wall surface was 65°. However, the random pattern was recorded on the groove of the magneto-optical disk in the same manner as in Comparative Example. The dependency of the bit error rate on the recording power and the dependency of the bit error rate on the reproducing power were investigated. Obtained results are shown in FIGS. 41 and 42 in order to make comparison with those obtained in the land recording.

According to FIGS. 41 and 42, it is appreciated that the power sensitivities in the recording and the reproduction with respect to the bit error rate can be increased when information is recorded on the groove portion as compared with the case in which information is recorded on the land portion. Accordingly, it is possible to reduce the electric power consumption of the drive of the magneto-optical recording and reproducing apparatus and consequently of the magneto-optical recording and reproducing apparatus itself.

### THIRTEENTH EMBODIMENT

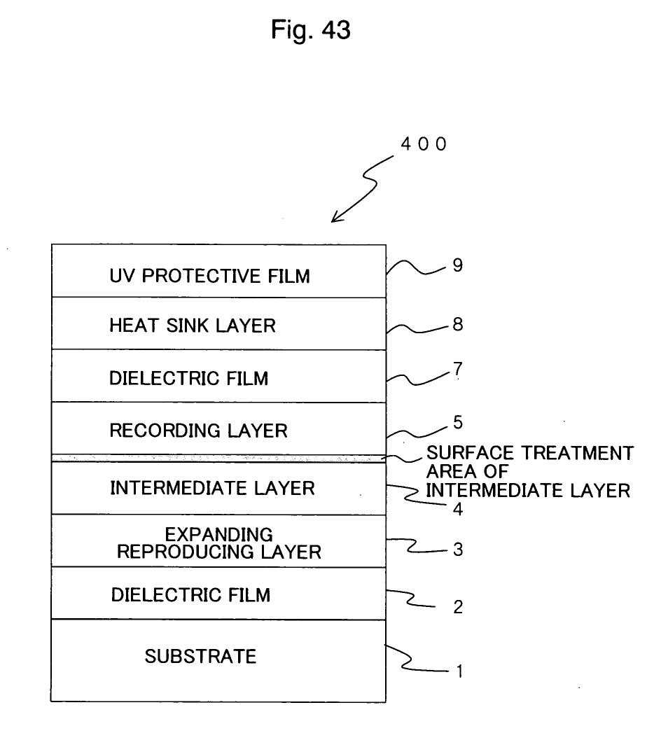

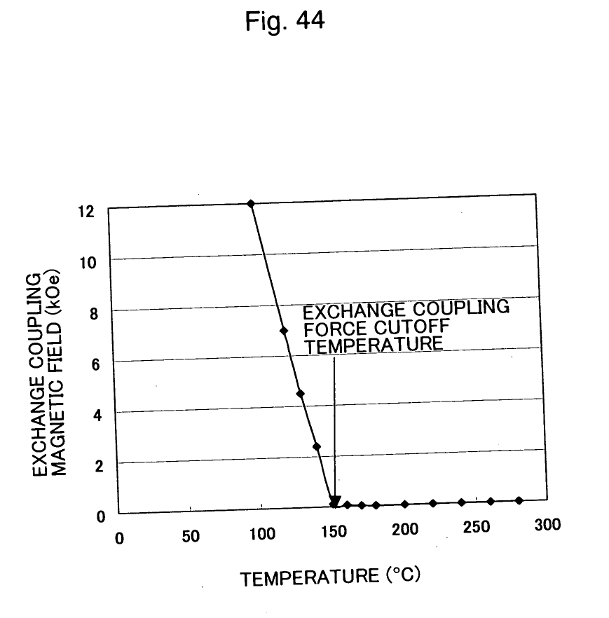

In this embodiment, a magneto-optical disk 400 having a structure as shown in FIG. 43 is produced. The magneto-optical disk 400 is the same as the magneto-optical disk manufactured in the first embodiment except for the expanding reproducing layer 3, the intermediate layer 4, and the recording layer 5. A rare earth transition metal alloy GdFe was formed as a film having a film thickness of 20 nm as the expanding reproducing layer 3 on the dielectric layer 2. The GdFe film had a Curie temperature of about 200° C. and a compensation temperature of not less than the Curie temperature. The saturation magnetization of the expanding reproducing layer 3 at 130° C. was about 50 emu/cm³.

A rare earth transition metal alloy TbGdFeCo, which had a compensation temperature of not more than room temperature, was formed as a film having a film thickness of 10 nm as the intermediate layer 4 on the expanding reproducing layer 3. The Curie temperature of the TbGdFeCo film was about 220° C. which was higher than the Curie temperature of the expanding reproducing layer. The ratio between Tb and Gd (Tb/Gd) in the TbGdFeCo film was 20%, and the ratio between Fe and Co (Fe/Co) was 15%. A treatment for slightly nitriding or oxidizing the surface of the intermediate layer is performed after the film formation of the intermediate layer 4.

The following treatment method is available. That is, an Ar gas mixed with nitrogen or oxygen may be introduced into a vacuum chamber of the sputtering apparatus after the film formation of the intermediate layer 4 to perform the sputtering etching for the stacked intermediate layer. According to this treatment, a nitride layer or an oxide layer, which is thin and which is, for example, a layer of one atom to several atoms, is formed on the surface of the intermediate layer 4. Alternatively, according to this treatment, the oxygen atom or the nitrogen atom is mixed into the surface of TbGdFeCo which constitutes the. intermediate layer 4. Therefore, the Curie temperature of the surface portion of the intermediate layer 4 is lowered. When the lowered Curie temperature is lower than the reproducing temperature, then the magnetization of the surface portion disappears by being irradiated with the reproducing light beam, and the exchange coupling force between the recording layer and the expanding reproducing layer is shielded or cut off. Therefore, it is possible to control the exchange coupling force between the recording layer and the expanding reproducing layer and the temperature-dependent change thereof independently from the temperature-dependent change of the magnetization of the intermediate layer. Without extinguishing the magnetization of the intermediate layer coupled to the expanding reproducing layer, the expanding reproducing layer is released from the exchange coupling force with respect to the recording layer critically at a certain temperature during the reproduction, the magnetic domain steeply begins to expand, and the magnetic domain expands up to the minimum magnetic domain diameter. A large reproduced signal is obtained from the expanded magnetic domain.

The degree of the surface treatment for the intermediate layer depends on, for example, the partial pressure ratio of nitrogen or oxygen with respect to the Ar gas as the sputtering gas, the total gas pressure, the introduced power, and the sputtering etching time. Therefore, the degree of the surface treatment can be appropriately adjusted. The following fact is important. That is, the temperature, at which the exchange coupling force is shielded or cut off at the interface between the intermediate layer 4 and the expanding reproducing layer 3, is set to be a temperature (high temperature) generated in the vicinity of the center of the spot of the reproducing light beam. Usually, it is considered that the temperature is 160 to 180° C. The temperature-dependent change of the exchange coupling force between the reproducing layer and the recording layer can be measured from the temperature-dependent change of the minor loop of the hysteresis curve as described above.

In this embodiment, the following surface treatment condition was adopted. That is, an Ar gas mixed with 5% nitrogen was introduced at a pressure of 0.3 Pa into the chamber, and an RF electric power of 50 W was applied to perform the sputtering etching for 3 seconds. Accordingly, the temperature, at which the exchange coupling force was cut off, was 160° C. The exchange coupling force cutoff temperature is lower than the Curie temperature (about 220° C.) of the intermediate layer as a result of the surface treatment of the intermediate layer. Therefore, the Curie temperature of the intermediate layer 4 can be set independently from the Curie temperature of the expanding reproducing layer 3. In general, as a result of the surface treatment for the intermediate layer 4, the exchange coupling force cutoff temperature is lower than the Curie temperature of the intermediate layer. Therefore, it is effective that the Curie temperature of the intermediate layer 4 is set to be higher than the Curie temperature of the expanding reproducing layer 3.

A rare earth transition metal alloy TbFeCo, which had a Curie temperature of 260° C. and a compensation temperature in the vicinity of room temperature, was formed as a film having a film thickness of 40 nm as the recording layer 5 on the intermediate layer 4 having been subjected to the surface treatment as described above. All of the three layers of the expanding reproducing layer 3, the intermediate layer 4, and the recording layer 5 were perpendicularly magnetizable films from room temperature to the Curie temperatures.

In the magneto-optical disk constructed as described above, the Curie temperature of the intermediate layer is higher than that of the expanding reproducing layer. However, the temperature, at which the exchange coupling force at the interface between the intermediate layer and the recording layer is cut off, is 160° C., and the magnetic domain expansion occurs at the same temperature as that in the eightth embodiment in which the Curie temperature of the intermediate layer is 150° C. Therefore, the recording and reproducing characteristics of the both were almost identical.

In this embodiment, the surface of the intermediate layer was treated after the film formation of the intermediate layer. However, the surface of the expanding reproducing layer may be treated in the same manner as described above after the film formation of the expanding reproducing layer. Alternatively, the surface of the recording layer disposed on the side of the intermediate layer may be treated. Alternatively, a substance, which lowers the Curie temperature in the vicinity of the interface, may be distributed in an island form over the interface between the intermediate layer and the recording layer or the interface between the intermediate layer and the expanding reproducing layer. Alternatively, the substance may be deposited to have a thickness of a layer of one atom to several atoms. A rare earth element or nickel may be used as the substance which lowers the Curie temperature. Alternatively, the surface treatment as described above may be performed during the deposition of the intermediate layer.

### Industrial Applicability

When the magneto-optical recording medium of the present invention is used, a sufficiently large reproduced signal is obtained, for example, even when circular magnetic domains having diameters of 0.3 micrometer are recorded in the recording layer 5. Therefore, in the present invention, it is unnecessary to perform any complicated treatment including, for example, a treatment in which the land portion or the groove portion is laser-annealed in order to smoothly expand the magnetic domain, and a treatment in which the recording film adhered to the boundary between the land portion and the groove portion is thinned by using any special film formation method. An amplified reproduced signal can be obtained from minute magnetic domains even when an ordinary substrate is used.

In the case of the magneto-optical recording medium of the present invention, the minute magnetic domains, which are recorded in the recording layer, can be transferred to the reproducing layer with the magnetization in the opposite direction, and they can be expanded in the reproducing layer without applying any reproducing magnetic field. Unlike DWDD and CARED, no ghost signal appears as well although the number of layers is small in the three-layered structure. Therefore, the magneto-optical recording medium of the present invention is extremely effective as a next-generation type large capacity magneto-optical recording medium.

The recording and reproducing power sensitivities can be increased by designing the substrate groove shape of the magneto-optical recording medium, especially of the magneto-optical recording medium based on the use of MAMMOS of the type in which no reproducing magnetic field is applied, with values included within the ranges described above, and especially adopting the system in which information is recorded on the groove. That is, the characteristics, which are obtained when the recording and the reproduction are performed on the magneto-optical recording medium, can be greatly improved as compared with those obtained in the conventional technique.

1. A magneto-optical recording medium comprising:
a recording layer which is formed of a magnetic material;
a reproducing layer which is formed of a magnetic material and which exhibits perpendicular magnetization; and
an intermediate layer which is formed of a magnetic material, which exists between the recording layer and the reproducing layer, and which cuts off an exchange coupling force between the recording layer and the reproducing layer at a temperature of not more than 160° C., wherein:
a compensation temperature Tcomp1 of the reproducing layer, a compensation temperature Tcomp2 of the intermediate layer, and a compensation temperature Tcomp3 of the recording layer satisfy one of the following expressions (1) and (2):
Tcomp2<120° C.<Tcomp1 (1)
Tcomp3<120° C.<Tcomp2 (2)

2. The magneto-optical recording medium according to claim 1, wherein the reproducing layer and the recording layer exhibit the perpendicular magnetization, the intermediate layer exhibits the perpendicular magnetization at a temperature of not more than 120° C., and the intermediate layer exhibits in-plane magnetization at a temperature of not less than 140° C.

3. The magneto-optical recording medium according to claim 1, wherein a substance, which is different from a substance for constructing the intermediate layer, is presented at an interface between the intermediate layer and the recording layer or at an interface between the intermediate layer and the reproducing layer, so that a Curie temperature at the interface or in the vicinity thereof is lower than a Curie temperature of the intermediate layer.

4. The magneto-optical recording medium according to claim 3, wherein the substance, which is different from the substance for constructing the intermediate layer, is introduced into the interface between the intermediate layer and the recording layer or into the interface between the intermediate layer and the reproducing layer by surface-treating the intermediate layer after formation of the intermediate layer.

5. The magneto-optical recording medium according to claim 1, wherein the intermediate layer has the compensation temperature which is not more than room temperature, and the intermediate layer has a Curie temperature which is not more than 160° C.

6. The magneto-optical recording medium according to claim 1, wherein an amount of change of magnetization on a low magnetic field side of a hysteresis curve of the magneto-optical recording medium at room temperature is 80 μemu to 220 μemu per 1 cm² of an areal size of the magneto-optical recording medium, when the magnetization of the magneto-optical recording medium is measured.

7. The magneto-optical recording medium according to any one of claims 1 to 6, wherein a temperature, at which the exchange coupling force between the recording layer and the reproducing layer is suddenly attenuated, is 120° C. to 180° C.

8. The magneto-optical recording medium according to any one of claims 2 to 4, wherein Tc1<Tc2<Tc3 is satisfied provided that Curie temperatures of the reproducing layer, the intermediate layer, and the recording layer are Tc1, Tc2, and Tc3 respectively.

9. The magneto-optical recording medium according to any one of claims 1 to 6, wherein a temperature gradient of Hexc at Hexc=3 kOe is not less than −100 Oe/° C. in a temperature area of not less than 100° C., in relation to a temperature-dependent change of an exchange coupling magnetic field Hexc between the recording layer and the reproducing layer.

10. The magneto-optical recording medium according to any one of claims 1 to 6, wherein magnetic domains, which are transferred from the recording layer to the reproducing layer when information is reproduced, are expanded by being irradiated with a reproducing light beam, and the information is reproduced from the expanded magnetic domains.

11. The magneto-optical recording medium according to any one of claims 1 to 6, wherein each of the recording layer and the intermediate layer is formed of a rare earth transition metal alloy in which magnetization of transition metal is dominant in the vicinity of a reproducing temperature, and the reproducing layer is formed of a rare earth transition metal alloy in which magnetization of transition metal is dominant in the vicinity of the reproducing temperature.

12. The magneto-optical recording medium according to any one of claims 1 to 6, wherein the recording layer is formed of a rare earth transition metal alloy in which magnetization of transition metal is dominant in the vicinity of a reproducing temperature, and each of the reproducing layer and the intermediate layer is formed of a rare earth transition metal alloy in which magnetization of transition metal is dominant in the vicinity of the reproducing temperature.

13. The magneto-optical recording medium according to any one of claims 1 to 6, wherein the reproducing layer is formed of a rare earth transition metal alloy which is mainly composed of GdFe.

14. The magneto-optical recording medium according to any one of claims 1 to 6, wherein the intermediate layer is formed of a rare earth transition metal alloy which is mainly composed of TbFe.

15. The magneto-optical recording medium according to any one of claims 1 to 6, wherein the recording layer is formed of a rare earth transition metal alloy which is mainly composed of TbFeCo or DyFeCo, and the recording layer has a Curie temperature of not less than 250° C. and the compensation temperature within a range of −100° C. to 100° C.

16. The magneto-optical recording medium according to any one of claims 1 to 6, wherein the reproducing layer has a film thickness of 15 nm to 30 nm.

17. The magneto-optical recording medium according to any one of claims 1 to 6, wherein the intermediate layer has a film thickness of 5 nm to 15 nm.

18. The magneto-optical recording medium according to any one of claims 1 to 6, wherein the reproducing layer has a saturation magnetization of 40 emu/cm³ to 80 emu/cm³ at 160° C., the intermediate layer has a saturation magnetization of not less than 40 emu/cm³ at 100° C., and the intermediate layer has a perpendicular magnetic anisotropy energy of not less than 0.4×10⁶ erg/cm³ at room temperature.

19. The magneto-optical recording medium according to any one of claims 1 to 6, wherein the intermediate layer is formed of a rare earth transition metal alloy which is mainly composed of TbGdFe, and an atomic ratio of Gd with respect to Tb is not more than ⅕.

20. The magneto-optical recording medium according to any one of claims 1 to 6, wherein the recording layer has a magnetic domain diameter of not more than 100 nm when AC demagnetization is performed at a temperature of not less than 150° C.

21. The magneto-optical recording medium according to any one of claims 1 to 6, wherein a reproduced waveform, which is obtained when an isolated magnetic domain is subjected to reproduction with a reproducing power that is ½ of Pr, has a signal intensity that is not more than ½ of A and a half value width that is not less than twice B, as compared with a signal intensity A and a half value width B of a reproduced waveform which is obtained when the isolated magnetic domain having a length of 0.2×L is subjected to recording at a cycle L with a reproducing power (Pr) capable of securing a maximum signal-to-noise ratio (C/N) for a recording magnetic domain having a length of 0.2×L provided that a wavelength of a laser beam is λ, a numerical aperture of an objective lens is NA, and a length that is twice λ/NA is the cycle L.

22. The magneto-optical recording medium according to any one of claims 1 to 6, wherein a relationship between a Curie temperature Tc3 of the recording layer and a Curie temperature Tc1 of the reproducing layer satisfies Tc1+30° C.<Tc3.

23. The magneto-optical recording medium according to any one of claims 1 to 6, wherein the recording layer includes a magnetic multilayer film constructed by stacking 5 to 40 sets of two-layered structures each of which comprises a magnetic layer mainly composed of Co having a film thickness of not more than 0.4 nm and a metal layer mainly composed of Pd or Pt having a film thickness of not more than 0.8 nm.

24. The magneto-optical recording medium according to any one of claims 1 to 6, wherein the recording layer is a layer which is formed in an atmosphere having a sputtering gas mainly composed of argon with a gas pressure of not less than 0.4 Pa.

25. The magneto-optical recording medium according to any one of claims 1 to 6, further comprising a substrate which has a refractive index n with a land and a groove, wherein information is reproduced by irradiating the magneto-optical recording medium with a light beam having a wavelength A through the substrate, and the groove has a depth within a range of λ/(16n) to λ/(5n).

26. The magneto-optical recording medium according to any one of claims 1 to 6, further comprising a substrate which has a land and a groove, wherein information is reproduced by irradiating the magneto-optical recording medium with a light beam having a wavelength λ from a side opposite to the substrate, and the groove of the substrate has a depth within a range of λ/16 to λ/5.

27. The magneto-optical recording medium according to any one of claims 1 to 6, further comprising a substrate on which a land and a groove are formed, wherein the substrate has a groove half value width G which is larger than a land half value width L.

28. The magneto-optical recording medium according to claim 27, wherein a ratio (G/L) between the groove half value width (G) and the land half value width (L) satisfies 1.3≦(G/L)≦4.0.

29. The magneto-optical recording medium according to any one of claims 1 to 6, wherein the reproducing layer exhibits the perpendicular magnetization within a temperature range of 20° C. to a temperature in the vicinity of a Curie temperature, and the compensation temperature is not less than the Curie temperature.

30. The magneto-optical recording medium according to claim 27, wherein an angle of inclination (θ) of a side wall surface of the land of the substrate is 40° to 75°.

31. The magneto-optical recording medium according to any one of claims 1 to 6, further comprising a substrate which has a land and a groove, wherein recording is performed on portions of both of the land and the groove, and a half value width of the groove is wider than a half value width of the land.

32. The magneto-optical recording medium according to any one of claims 1 to 6, further comprising a substrate which has a land and a groove, wherein recording is performed on one of the land and the groove, and one of the land and the groove, on which the recording is performed, has a half value width which is wider than that of the other.

33. A reproducing method on the magneto-optical recording medium, comprising irradiating the magneto-optical recording medium as defined in claim 1 with a reproducing light beam to effect heating to a temperature not less than a temperature at which the exchange coupling force between the recording layer and the reproducing layer is cut off so that information is reproduced from the magneto-optical recording medium.

34. The reproducing method on the magneto-optical recording medium according to claim 33, wherein a recording magnetic domain is detected before the recording magnetic domain, which is intended to be subjected to the reproduction, arrives at a center of the reproducing light beam.

35. The reproducing method on the magneto-optical recording medium according to claim 33, wherein a magnetic domain, which is transferred from the recording layer to the reproducing layer, is expanded without applying any magnetic field during the reproduction.
